(19) United States
(12) Patent Application Publication
(10) Pub. No.: US 2016/0357913 A1
(43) Pub. Date: Dec. 8, 2016

(54) COMPUTERIZED MEDICAL RECORD CODING SYSTEM AND METHOD USING CODE MODELS

(71) Applicant: Humana Inc., Louisville, KY (US)

(72) Inventor: Michael Christner, Sellersburg, IN (US)

(73) Assignee: HUMANA INC., Louisville, KY (US)

(21) Appl. No.: 14/227,604

(22) Filed: Mar. 27, 2014

Related U.S. Application Data
(63) Continuation-in-part of application No. 13/769,981, filed on Feb. 19, 2013.
(60) Provisional application No. 61/599,674, filed on Feb. 16, 2012.

(51) Int. Cl. G06F 19/00

(52) U.S. Cl. CPC G06F 19/322

(57) ABSTRACT

A computerized system and method that allows healthcare providers to update the medical codes in health benefits provider member records using medical code models. Each medical code model has an identifier and associated medical codes. Each member record has a code model identifier that indicates which set of medical codes are appropriate for the member's medical conditions. In an example embodiment, the code model identifiers include a medical hierarchical condition code model, and an end-stage renal disease code model. When medical conditions are affirmed or added to a member's database medical record, the member's code model identifier is used to select the set of medical codes from which a computer user can choose. The use of the medical code model identifier limits a user's selection of medical codes and as a result, reduces the likelihood of medical record coding errors.

### CROSS-REFERENCE TO RELATED APPLICATIONS

This application is a continuation-in-part of U.S. application Ser. No. 13/769,981, filed Feb. 19, 2013 and titled COMPUTERIZED SYSTEM AND METHOD FOR CODING MEDICAL RECORDS TO FACILITATE PROVIDER REIMBURSEMENTS, which claims priority to U.S. Provisional Application Ser. No. 61/599,674, filed Feb. 16, 2012 and titled COMPUTERIZED SYSTEM AND METHOD FOR CODING MEDICAL RECORDS TO FACILITATE PROVIDER REIMBURSEMENTS, the contents of which are incorporated herein by reference.

### BACKGROUND OF THE INVENTION

To facilitate reimbursements to healthcare providers, organizations such as the Centers for Medicare & Medicaid Services (CMS) and other health benefits payors require coding of medical records. Coding classifications, such as CMS's hierarchical condition categories (Medical HCC Model), CMS's end-stage renal disease codes (ESRD HCC Model) and CMS's prescription codes (Rx Model), are used to identify numerous health or medical conditions as well as prescriptions relevant to a patient's health. For example, one code identifies chronic pulmonary heart disease while another code identifies a diabetes health condition. The patient record of an individual with multiple chronic health conditions will have multiple codes identifying each of the associated health conditions. For example, an individual who has arthritis may also have osteoporosis and high blood pressure. The patient's electronic medical record therefore, may have a first code for arthritis, a second code for osteoporosis, and a third code for high blood pressure.

Codes may be identified for medical records by healthcare providers, health benefit providers, and other organizations that may be granted access to a patient's records. Although great care is taken in coding medical records properly, errors and omissions can occur. For example, a healthcare provider may fail to add to a patient's record a code for a newly diagnosed health condition or to provide the correct code for the specific symptom of a patient's health condition. For example, various codes for renal failure are used to identify specific characteristics of the disease. In other instances, a healthcare provider may overlook codes for secondary conditions or complications related to a patient's primary problems. For example, a diabetic patient may occasionally present with a urinary tract infection or mild malnutrition that are identified by specific codes that differ from diabetes codes. To facilitate reimbursement and for other reasons, it is important for medical records to be coded completely and accurately. CMS, for example, uses HCC codes that are correlated to diagnosis codes to adjust capitation payments to private health care plans for the health expenditure risk of their members.

Because the information most relevant to an individual's health status typically originates at a healthcare provider reimbursed by a health benefits provider or other third party payor, medical records received by payors are initially coded according to data received from the healthcare provider. The coding details are typically obtained from the provider's claim or request for reimbursement. Records are not always coded correctly and when coding errors are discovered, they are often discovered in connection with claims for reimbursement. Because the provider's reimbursement depends upon proper medical record coding, including the use of an appropriate code model, it is important for providers to have the ability to correct or change codes when questions regarding the coding are raised or when coding errors are discovered.

Although coding problems may be resolved in various ways such as through direct communications between the healthcare provider and health benefits provider or payor, this approach is neither the most efficient nor effective. The volume of claims generated by healthcare providers and received by health benefits providers is so great that resolving problems by telephone, email, or fax communications is impractical. Even if the individuals involved in the telephone, email, or fax communications reach agreement on the resolution of a coding problem, one or more associated electronic medical or claims records must be updated.

There is a need for a computerized system and method that allows healthcare providers to access and modify medical record codes for member medical database records of a health benefits provider. In particular, there is a need for a computerized system and method that allows healthcare providers to use an appropriate coding model and to further respond to “suspect conditions” identified in member medical database records for a member population using an appropriate set of medical codes. There is a need for a computerized system and method that allows healthcare providers using the correct medical code model to enter and correct codes for medical database records stored at a health benefits provider and used for reimbursement of services.

### SUMMARY OF THE INVENTION

The present disclosure is directed to a web-based tool that grants healthcare providers the ability to make real-time updates to the medical codes in health benefits provider member medical database records. In an example embodiment, healthcare providers access and update “suspect conditions” in a health benefits provider's Suspect Tracking And Reporting (STAR) database. The health benefits provider receives claims for services provided to its members as well as associated, supporting medical records and documentation for the claims. In connection with processing claims for reimbursement, the health benefits provider enters and tracks the claim and related medical data in a database and identifies one or more “suspect conditions.” The healthcare provider is provided with access to the database records and permitted to update records with codes from the appropriate code model (i.e. Medical HCC Model or ESRD HCC Model) while researching “suspect conditions” in supporting documentation and data. The healthcare provider may review written reports and other relevant data to affirm or deny the “suspected condition” identified in a member record. As a result, healthcare providers and the health benefits provider are assured that all data associated with a patient's medical record is as current, complete, and accurate as possible. The affirmed condition data for a member population along with revised encounter submissions may further be used in projecting risk scores to the population and a level of reimbursement for the healthcare provider.

### BRIEF DESCRIPTION OF THE DRAWINGS

FIG. 1 is a member search screen according to an example embodiment;

FIGS. 2A and 2B are member search results screens according to an example embodiment;

FIG. 3A is a member HCC profile screen for a Medical HCC Model member according to an example embodiment.

FIG. 3B is a member HCC profile screen for an ESRD HCC model member according to an example embodiment;

FIG. 4A is an example affirm condition screen for Medical HCC Model codes according to an example embodiment;

FIG. 4B is an Affirm Condition screen according to an example embodiment;

FIG. 5A is an example affirm condition screen for ESRD HCC Model codes according to an example embodiment;

FIG. 5B is an Affirm Condition screen according to an example embodiment;

FIGS. 6A and 6B are updated Member HCC Profile screens according to an example embodiment;

FIGS. 7A and 7B are example Member HCC Profile screens according to an example embodiment;

FIG. 8A is an example Add Affirmed Condition screen for a Medical HCC Model member according to an example embodiment;

FIG. 8B is a first Member HCC Profile screen according to an example embodiment;

FIG. 9A is an example Add Affirmed Condition screen for an ESRD Model member according to an example embodiment

FIG. 9B is a second Member HCC Profile screen according to an example embodiment;

FIG. 10A is a current status Member HCC Profile screen for a Medical HCC Model member according to an example embodiment;

FIG. 10B is an updated status Member HCC Profile screen for a Medical HCC Model member according to an example embodiment;

FIG. 11A is a current status Member HCC Profile screen for an ESRD HCC Model member according to an example embodiment;

FIG. 11B is an updated status Member HCC Profile screen for an ESRD HCC Model member according to an example embodiment;

FIG. 12 is an Activity Log report screen according to an example embodiment;

FIG. 13 is a Condition Status Summary report screen according to an example embodiment;

FIG. 14 is a Member Listing—By Condition Status report screen according to an example embodiment;

FIG. 15A is a first Member Listing—By HCC search screen according to an example embodiment;

FIG. 15B is a first Member Listing—By HCC report screen according to an example embodiment;

FIG. 16A is a second Member Listing—By HCC search screen according to an example embodiment;

FIG. 16B is a second Member Listing—By HCC report screen according to an example embodiment;

FIG. 17A is a condition history screen for a Medical HCC Model member according to an example embodiment; and

FIG. 17B is a condition history screen for an ESRD HCC Model member according to an example embodiment.

### DETAILED DESCRIPTION

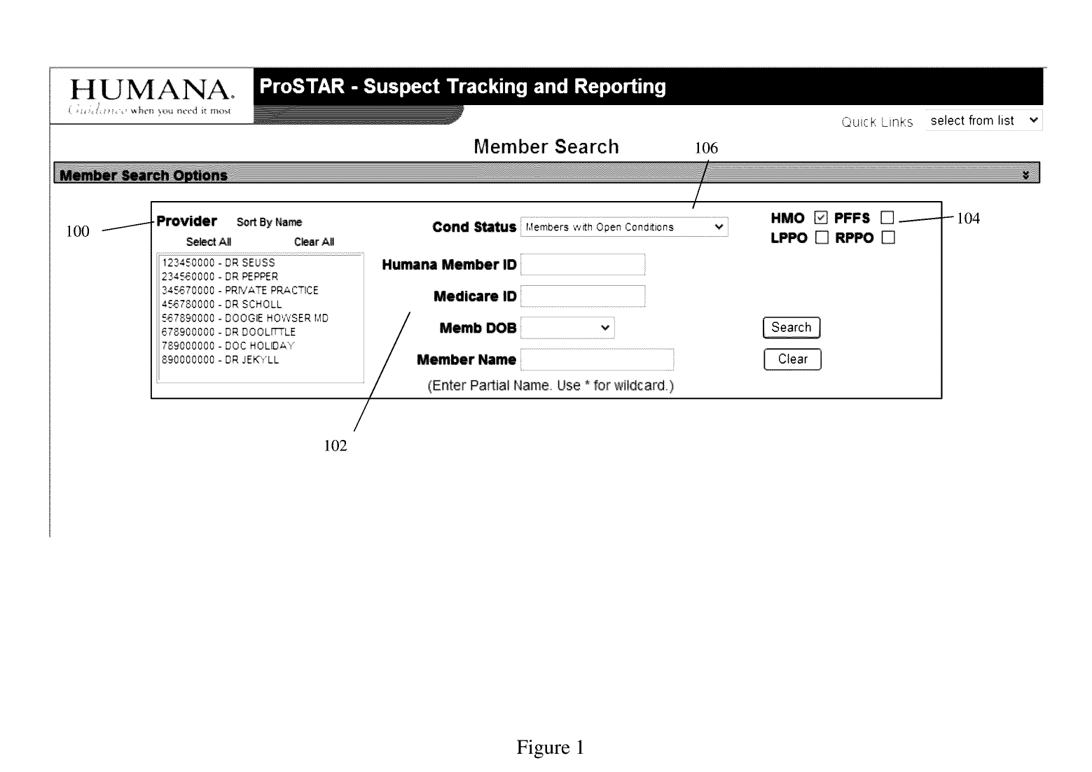

Referring to FIG. 1, a member search screen according to an example embodiment is shown. A user can search for a member by selecting any combination of search criteria. In addition to searching by provider 100, member identifier, Medicare identifier, member date of birth, member name 102, or product type (HMO, PFFS, LPPO, or RPPO) 104, a user may select a condition status 106. In an example embodiment, the member status conditions may include the following.

TABLE 1
Condition Status Categories

| | |
|---|---|
| Level One Open | Conditions more likely to be seen in a provider |
| Conditions | office setting than a hospital setting. Example |
| | “level one” Conditions are listed in Table 2. |
| Members with Open | List of members having at least one open suspect |
| Conditions | condition, regardless of whether the open |
| | condition is a “level one” condition. All of |
| | a member's conditions are displayed as long as |
| | that member has at least one open condition. |
| Affirmed | List of members having at least one affirmed |
| Conditions | condition. All of a member's conditions are |
| | displayed as long as that member has at least |
| | one affirmed condition. |
| “CMS accepted” | List of members having at least one CMS accepted |
| Conditions | condition. All of a member's conditions are |
| | displayed as long as that member has at least |
| | one CMS accepted condition. |
| Denied Conditions | List of members having at least one denied |
| | condition. All of a member's conditions are |
| | displayed as long as that member has at least |
| | one denied condition. |
| Conditions | List of members having at least one condition, |
| | regardless of the status of that condition |
| | (Open, Affirmed, “CMS accepted”, etc.). |
| No Conditions | List of members that do not have any conditions. |
| Total Membership | List of all members associated with the selected |
| | physician, regardless of whether the members |
| | have any conditions or not. |

TABLE 2
Example “Level One” Conditions

| HCC | DESCRIPTION |
|---|---|
| 10A | BREAST, PROSTATE, COLORECTAL AND OTHER |
| | CANCERS AND TUMORS |
| 15A | DIABETES WITH RENAL OR PERIPHERAL |
| | CIRCULATORY MANIFESTATION |
| 16A | DIABETES WITH NEUROLOGIC OR OTHER |
| | SPECIFIED MANIFESTATION |
| 18A | DIABETES WITH OPHTHALMOLOGIC OR |
| | UNSPECIFIED MANIFESTATION |
| 19A | DIABETES WITHOUT COMPLICATION |
| 27A | CHRONIC HEPATITIS |
| 38A | RHEUMATOID ARTHRITIS AND INFLAMMATORY |
| | CONNECTIVE TISSUE DISEASE |
| 68A | PARAPLEGIA |
| 71A | POLYNEUROPATHY |
| 73A | PARKINSON'S AND HUNTINGTON'S DISEASES |
| 74A | SEIZURE DISORDERS AND CONVULSIONS |
| 80A | CONGESTIVE HEART FAILURE |
| 83A | ANGINA PECTORIS/OLD MYOCARDIAL INFARCTION |
| 92A | SPECIFIED HEART ARRHYTHMIAS |
| 100A | HEMIPLEGIA/HEMIPARESIS |
| 105A | VASCULAR DISEASE |
| 108A | CHRONIC OBSTRUCTIVE PULMONARY DISEASE |
| 130A | DIALYSIS STATUS |
| 131A | RENAL FAILURE |
| 132A | NEPHRITIS |
| 149A | CHRONIC ULCER OF SKIN, EXCEPT DECUBITUS |
| 176A | ARTIFICIAL OPENINGS FOR FEEDING OR |
| | ELIMINATION |
| 177A | AMPUTATION STATUS, LOWER LIMB AMPUTATION |
| | COMPLICATIONS |

Selection of the “level one open conditions” search criteria returns a list of members that have at least one open “level one” condition. In addition to displaying open “level one” conditions, the Member HCC Profile also includes all known conditions for a member, regardless of suspect status.

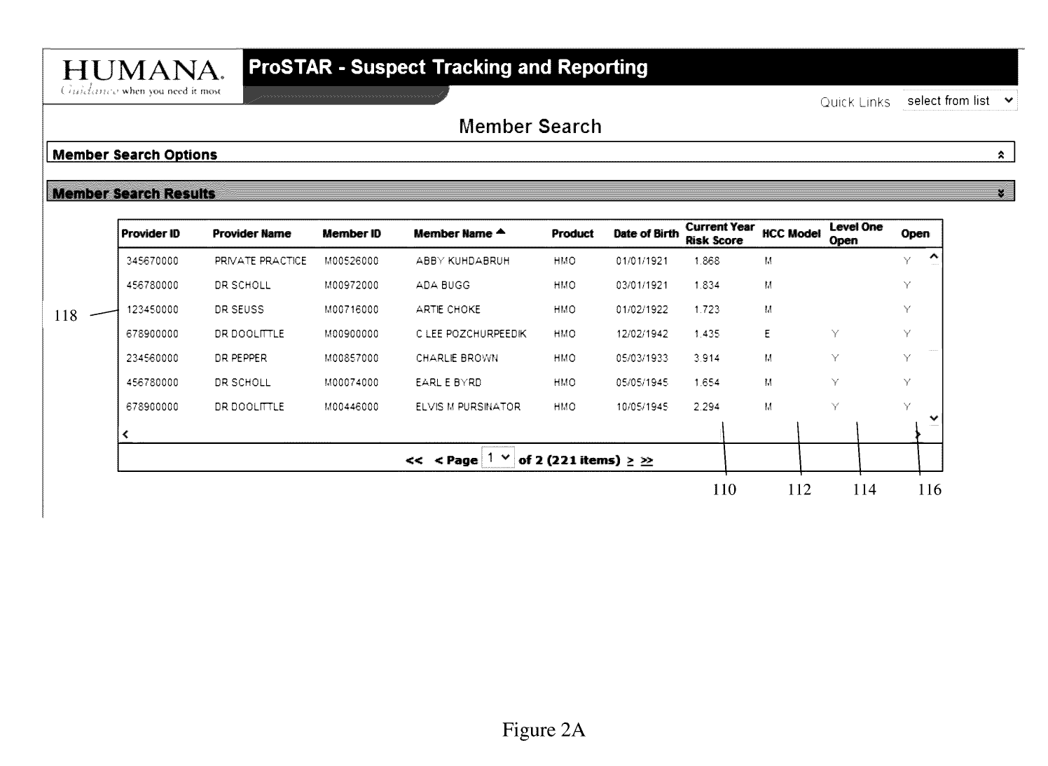

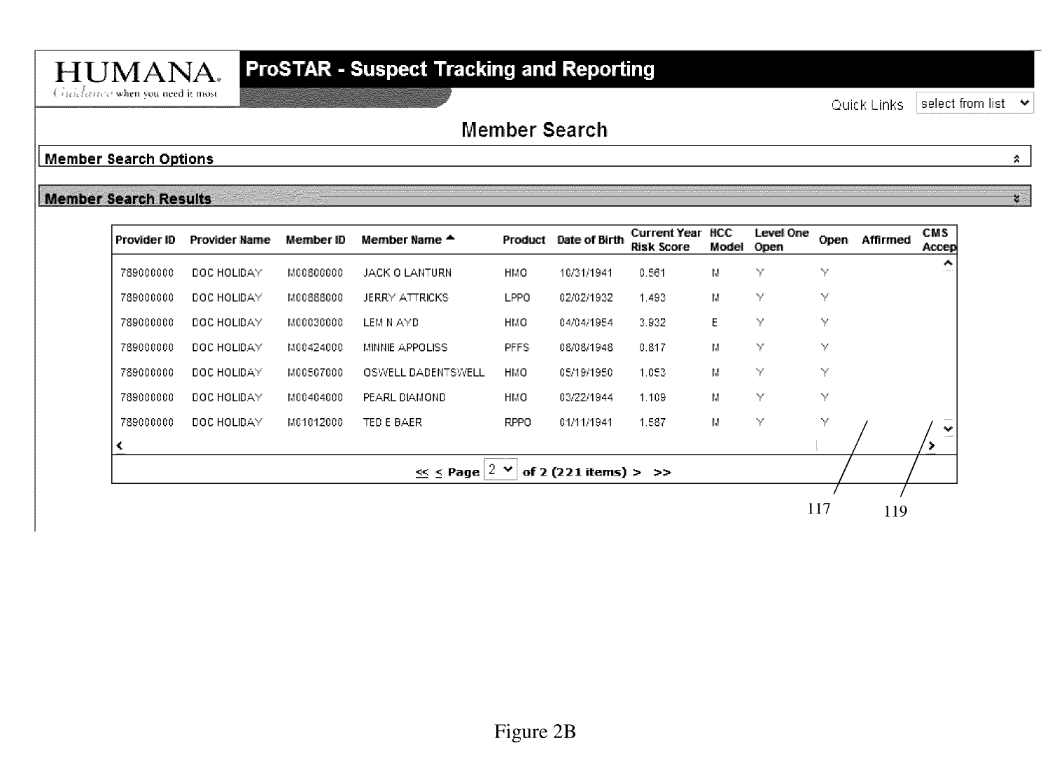

Referring to FIGS. 2A and 2B, a member search results screen according to an example embodiment is shown. The member search results screen displays all records that match the search criteria selected or entered in the member search screen. In addition to displaying results for the fields from the member search screen, the search results screen displays the members' current risk score 110, applicable HCC model 112, and indicators for the members' Level One open conditions 114, open conditions 116, affirmed conditions 117, and CMS accepted conditions 119. In an example embodiment, the HCC model indicator identifies an applicable set of codes for the member's medical records. In an example embodiment, the code models include the following.

TABLE 3
Code Models

| | |
|---|---|
| 2 Medical HCC Models | 149 conditions eligible for |
| General Medical Hierarchical | Medicare Risk Adjustment |
| Condition Codes | |
| 1 ESRD HCC Model | 87 conditions eligible for |
| End Stage Renal Disease | Medicare Risk Adjustment |
| Hierarchical Condition Codes | |

The application of a code model reduces improper coding by limiting a user's selection to the appropriate codes for the member's conditions.

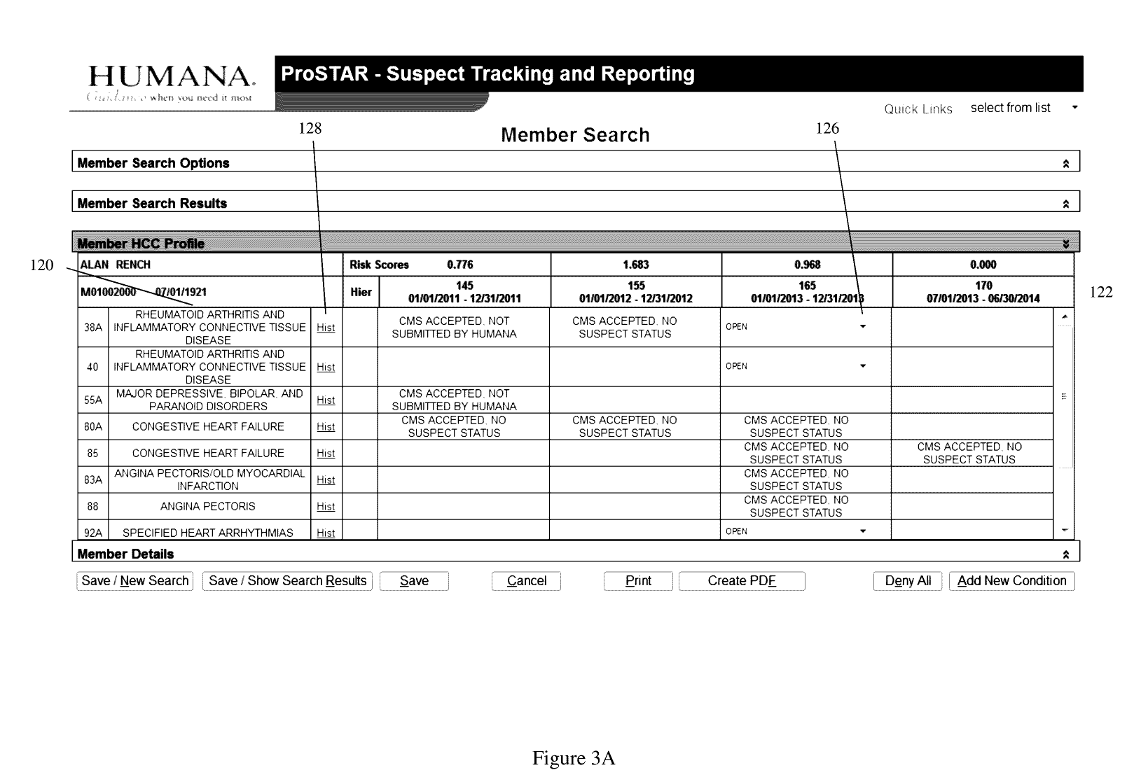

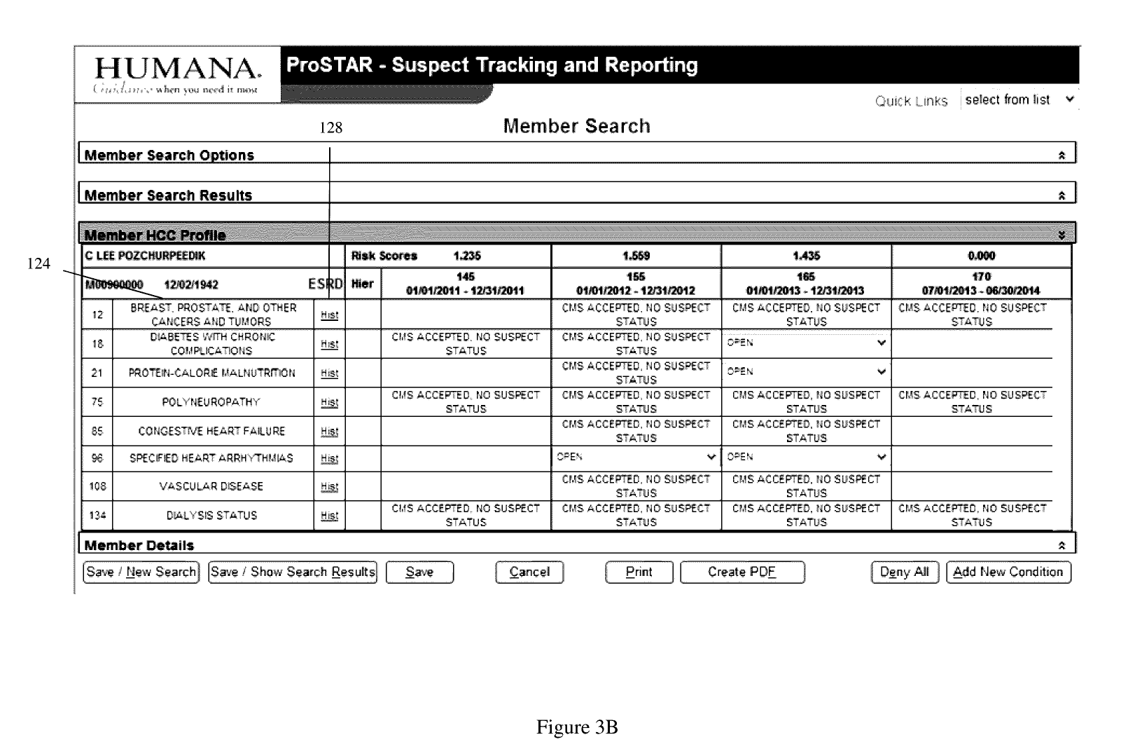

By selecting one of the rows of member data 118, a user can view the member's HCC profile. Referring to FIG. 3A, a member HCC profile screen for a Medical HCC Model according to an example embodiment is shown. In the example, the member's conditions 120 are defined by two Medical HCC Model which combined include 149 health conditions eligible for Medicare Risk Adjustment. The member's health conditions, both confirmed and suspected, are displayed for multiple CMS data collection periods 122. Referring to FIG. 3B, a member HCC profile screen for an ESRD HCC model member is shown. The member's ESRD conditions 124 are defined by the ESRD HCC Model which includes 87 health conditions eligible for Medicare Risk Adjustment.

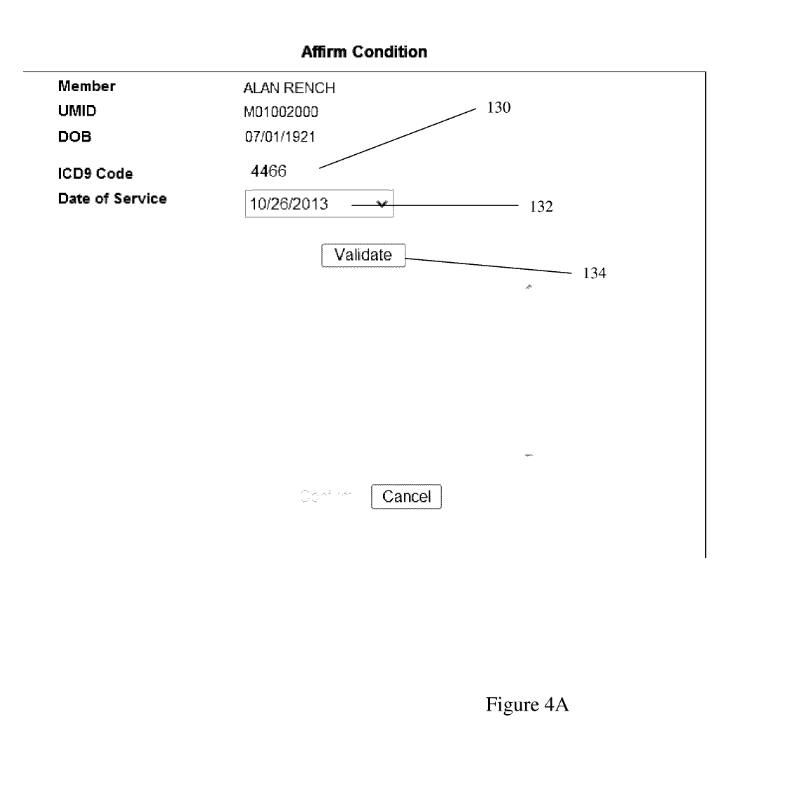

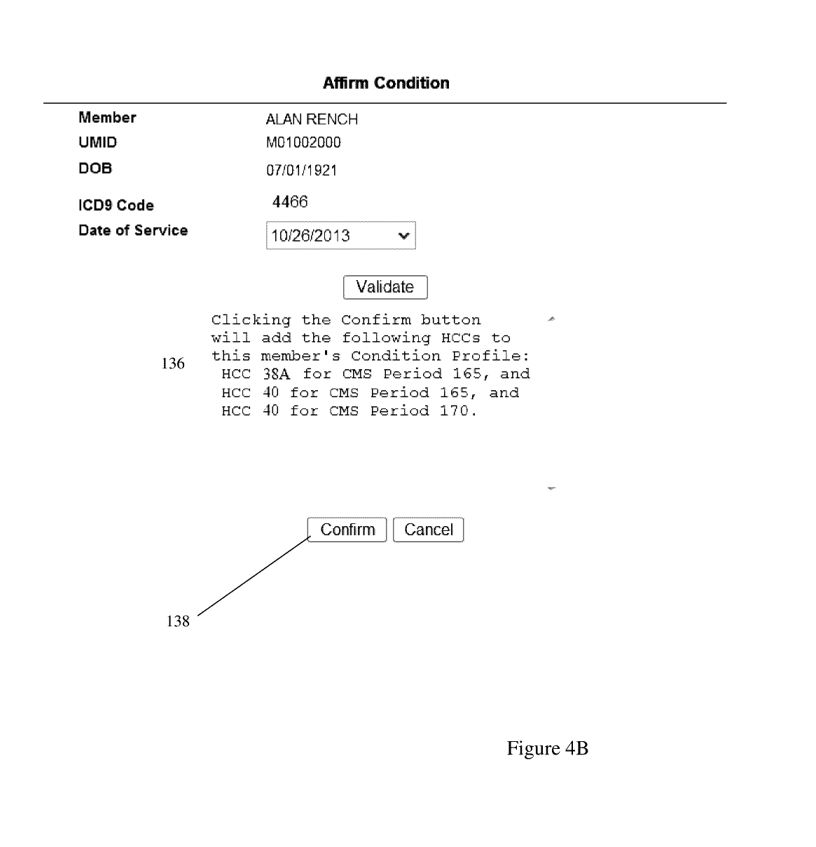

Referring again to FIG. 3A, to confirm a condition in a member's HCC profile, a user selects a drop-down arrow next to a suspect condition 126 (i.e., a condition with an “Open” status) in the member HCC profile screen. The user then selects the “Provider Affirmed Condition” option (not shown) from a drop-down list which causes an affirm condition screen to appear. Referring to FIG. 4A, an example Affirm Condition screen for Medical HCC Model codes according to an example embodiment is shown. The user enters a diagnosis code 130 such as an ICD9 code specific to the condition to be affirmed. The user is also prompted to enter a Date of Service 132. After entering the required information, the user selects the Validate option 134 to verify that the diagnosis code is valid for the Date of Service entered. Referring to FIG. 4B, a message 136 is displayed below the Validate option, informing the user which health condition will be updated when the Confirm option 138 is selected. Selecting the Confirm option completes the condition status update operation.

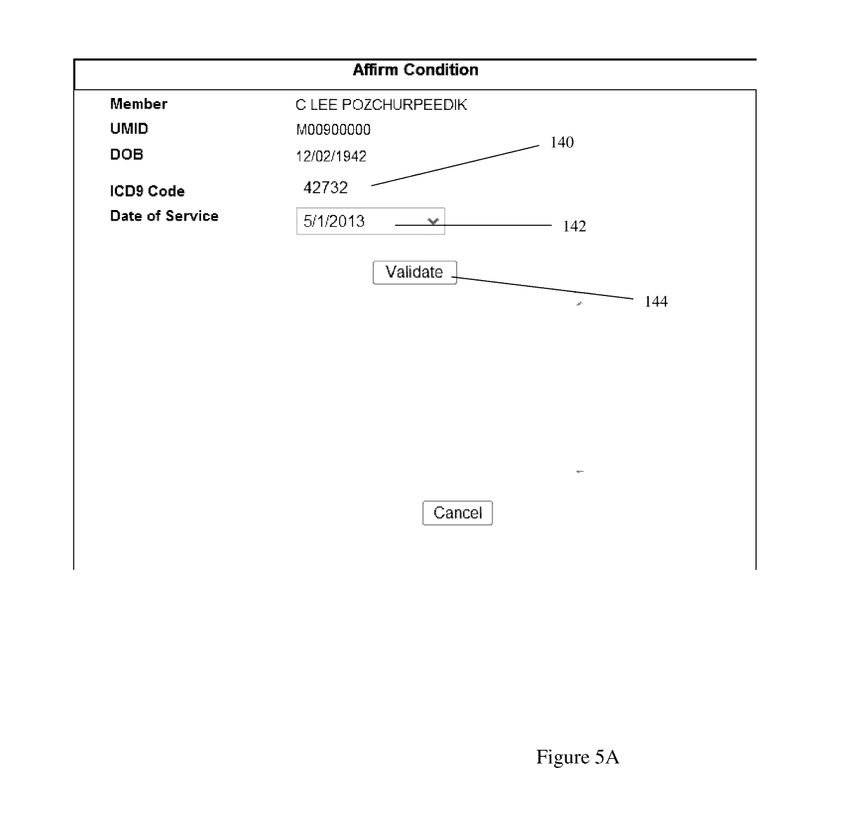

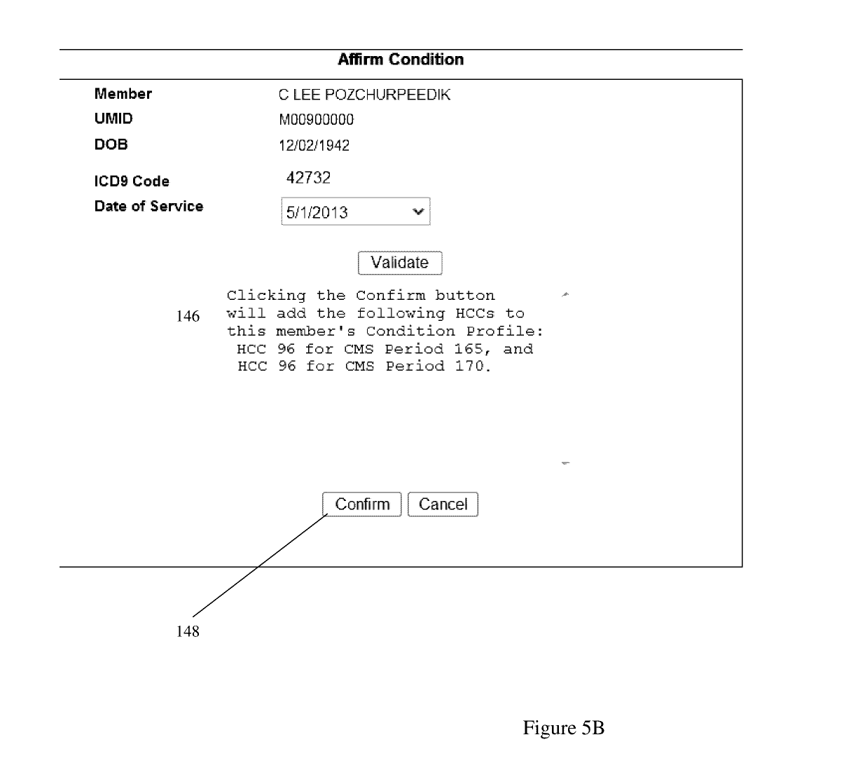

Referring to FIG. 5A, an example Affirm Condition screen for ESRD HCC Model codes according to an example embodiment is shown. In the example, the user enters a diagnosis code 140 and a Date of Service 142, then selects the Validate option 144. Referring to FIG. 5B, a message 146 is displayed below the Validate option, informing the user which health conditions will be updated when the Confirm option 148 is selected. Selecting the Confirm option 148 completes the condition status update operation.

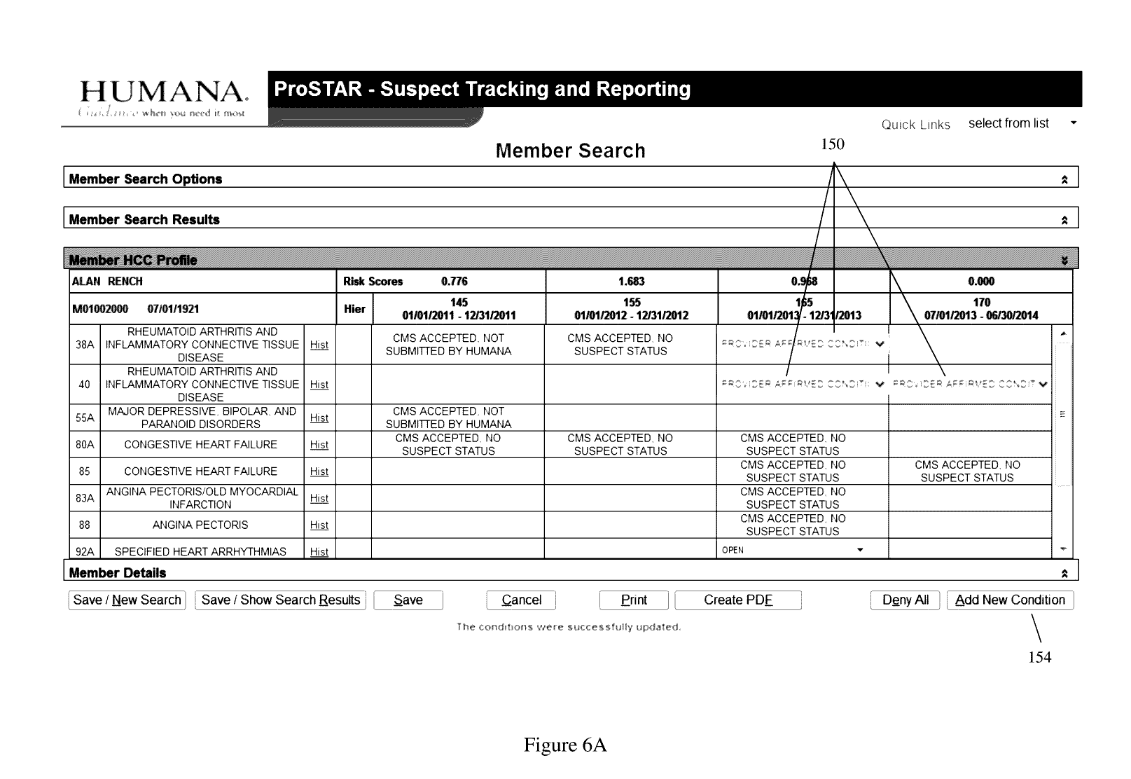

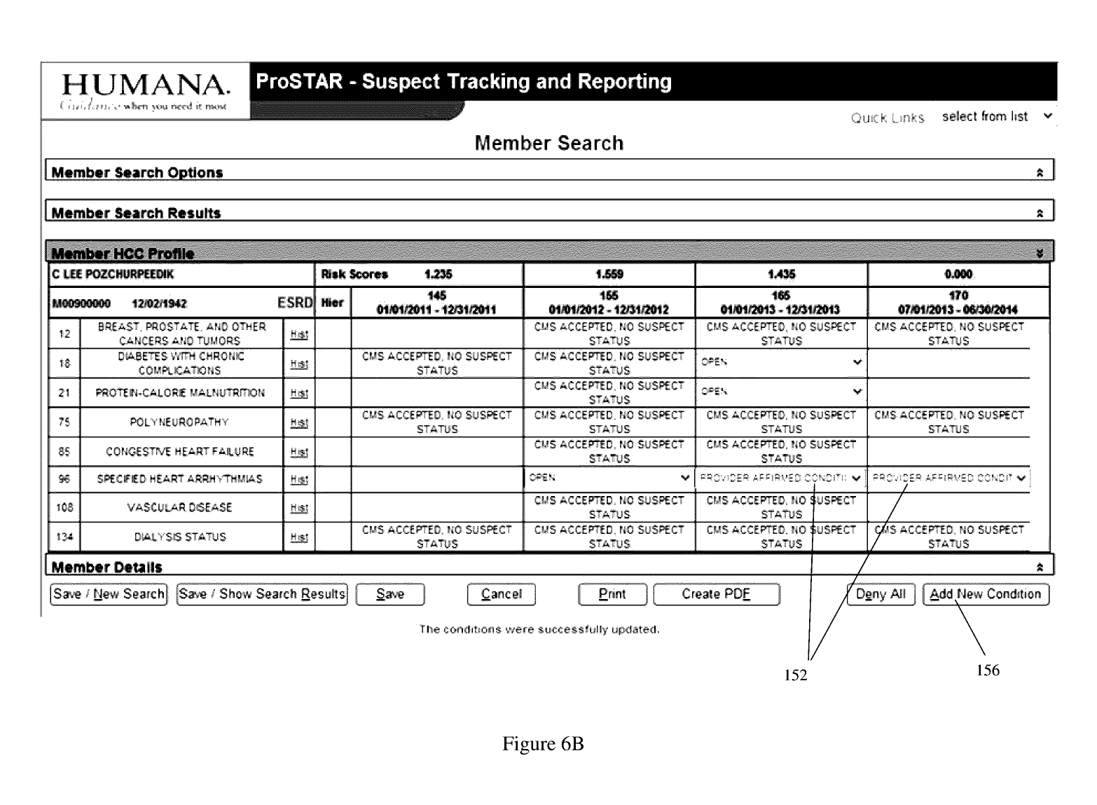

After completing a condition status update operation by selecting the Confirm option 148, the user returns to the Member HCC Profile screen which reflects the updated health condition status. Referring to FIG. 6A, an updated Member HCC Profile screen corresponding to the Member HCC Profile screen of FIG. 3A (Medical HCC Model) is shown. The screen of FIG. 6A reflects the updated health condition status for condition 38A Rheumatoid Arthritis and Inflammatory Connective Tissue Disease for CMS period 01/01/2013-12/31/2013 (165) and for condition 40 Rheumatoid Arthritis and Inflammatory Connective Tissue Disease for the CMS periods 01/01/2013-12/31/2013 (165) and 07/01/2013-06/30/2014 (170). The status is changed from “Open” to “Provider Affirmed Condition” 150. Referring to FIG. 6B, an updated Member HCC Profile screen corresponding to the Member HCC Profile screen of FIG. 3B (ESRD HCC Model) is shown. The screen of FIG. 6B reflects the updated condition status for condition 96 Specified Heart Arrhythmias by indicating the condition status of “Open” for the periods 01/01/2013-12/31/2013 (165) and 07/01/2013-06/30/2014 (170) is now “Provider Affirmed Condition” 152.

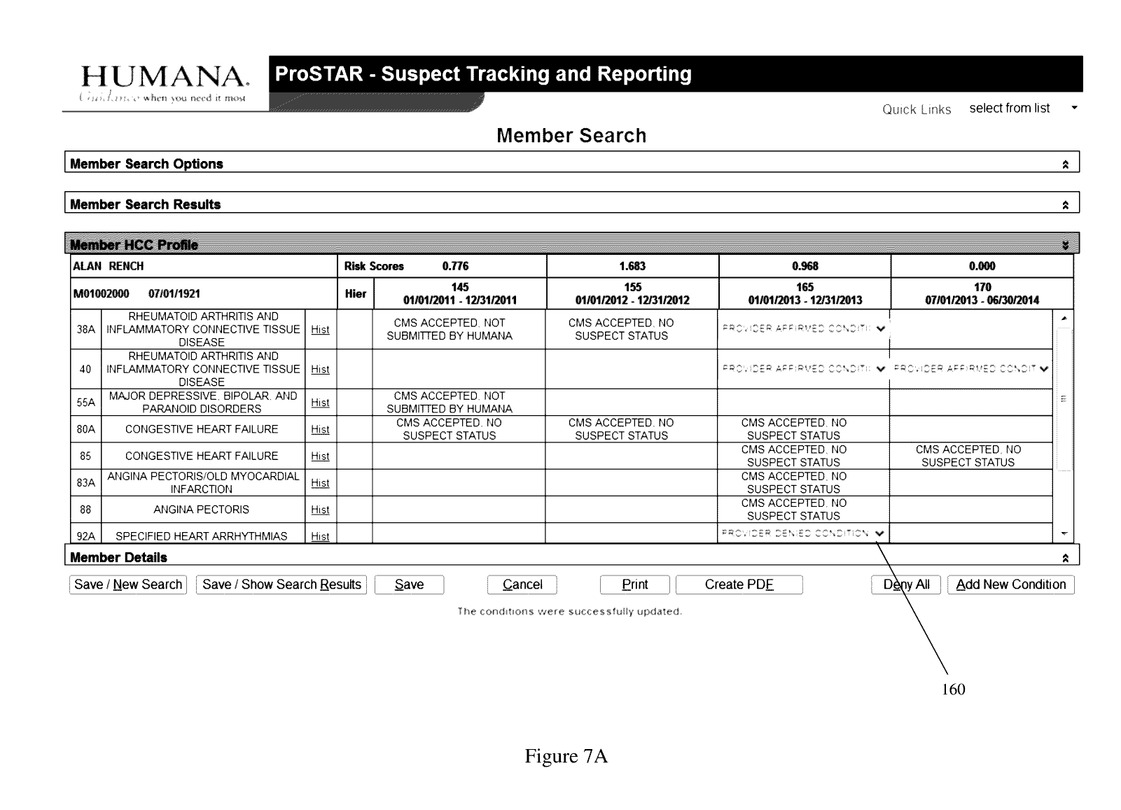

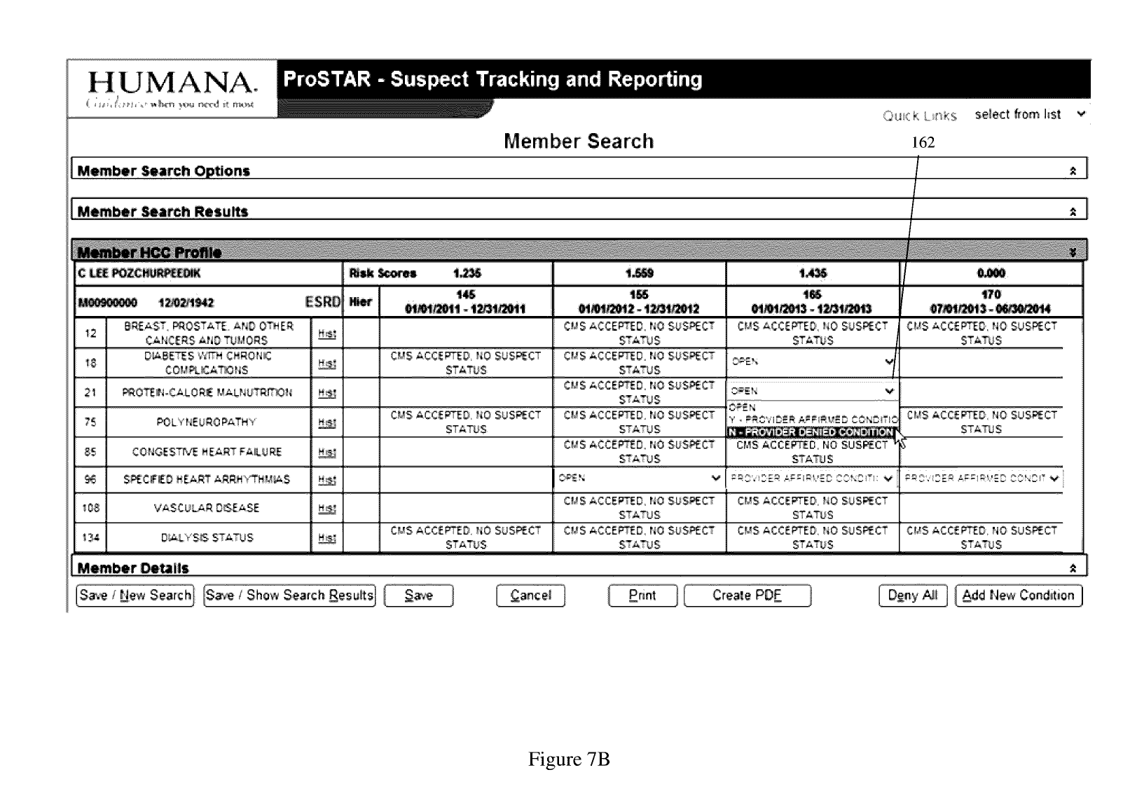

Referring to FIG. 7A, an example Member HCC Profile screen according to an example embodiment is shown. If a user cannot find documentation to support the presence of a suspect condition for a specific CMS data collection period, the user may change the “Open” status of the suspect condition to “Provider Denied Condition” by selecting the option from a drop-down menu 160. Following selection of the option, the screen appears as shown in FIG. 7A for the Medical HCC Model. Similarly, the screen appears as shown in FIG. 7B (ESRD HCC Model) following selection of the Provider Denied Condition option 162.

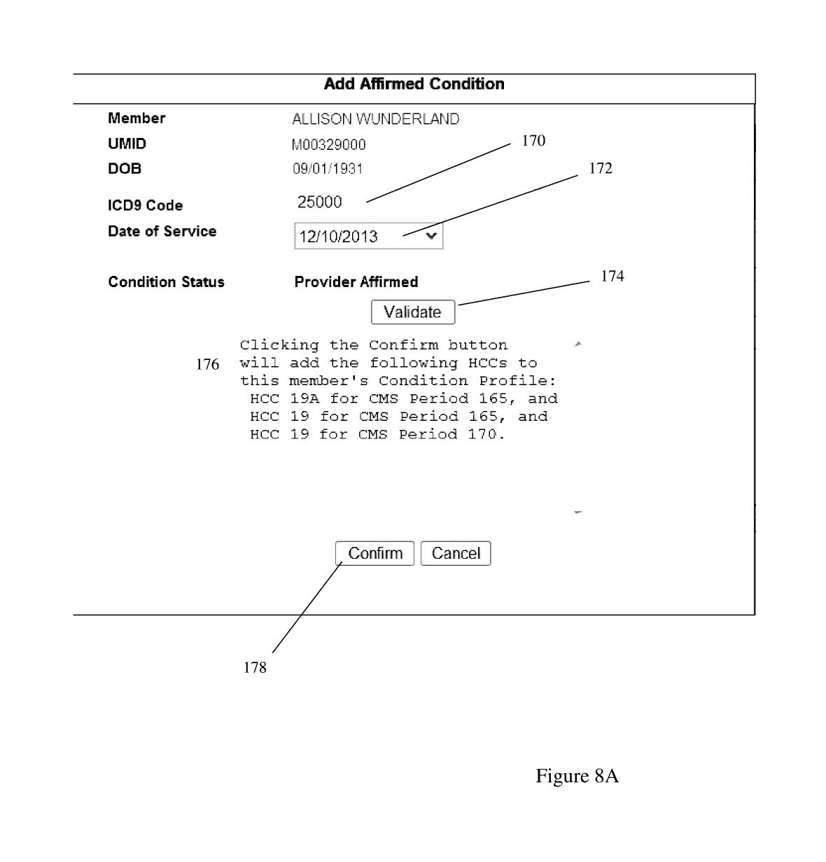

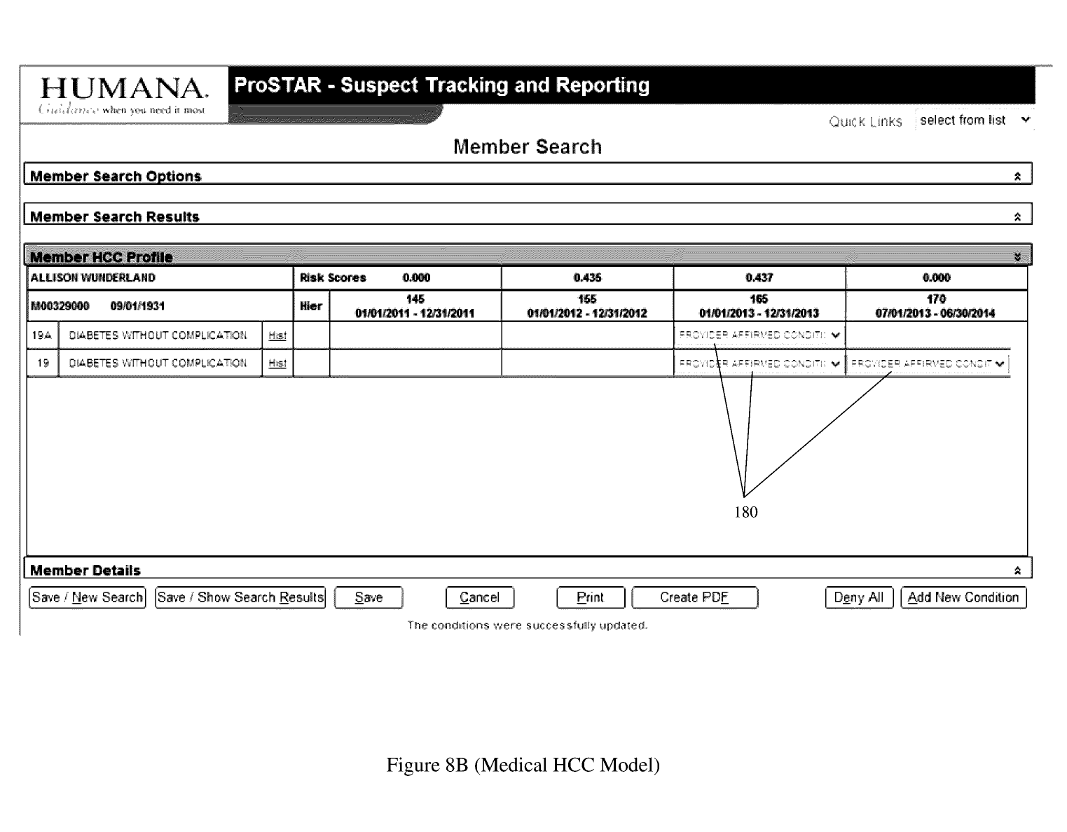

In addition to confirming or denying conditions, a user may add a health condition to a Member's HCC Profile. After selecting the Add New Condition option 154 as shown in FIG. 6A for Medical HCC Model or FIG. 6B for ESRD HCC Model 156, an Add Affirmed Condition screen appears. Referring to FIG. 8A, an example Add Affirmed Condition screen for a Medical HCC Model member according to an example embodiment is shown. The user is prompted to enter a diagnosis code such as an ICD9 code 170, and the Date of Service 172. Next, the user performs a validation step by selecting the Validate option 174. A message 176 is displayed below the Validate option, informing the user which health condition codes will be added when the Confirm option 178 is selected. Selecting the Confirm option 178 causes the new conditions to be added to the member's profile. Referring to FIG. 8B (Medical HCC Model), the new conditions appear in the member profile as a “Provider Affirmed Condition” 180.

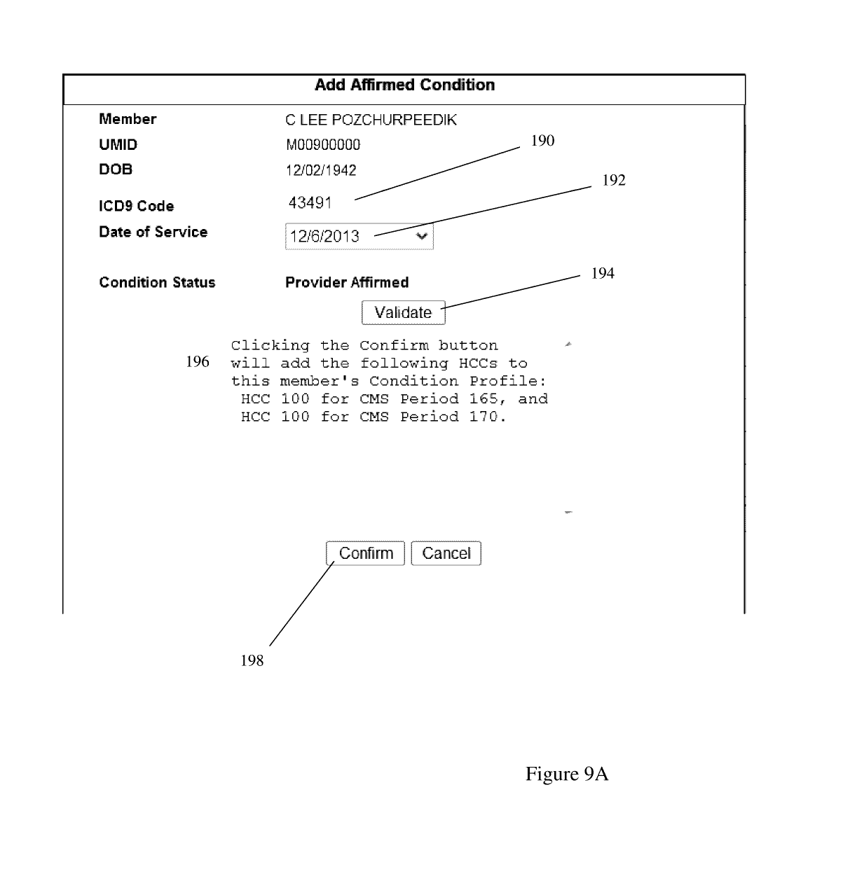

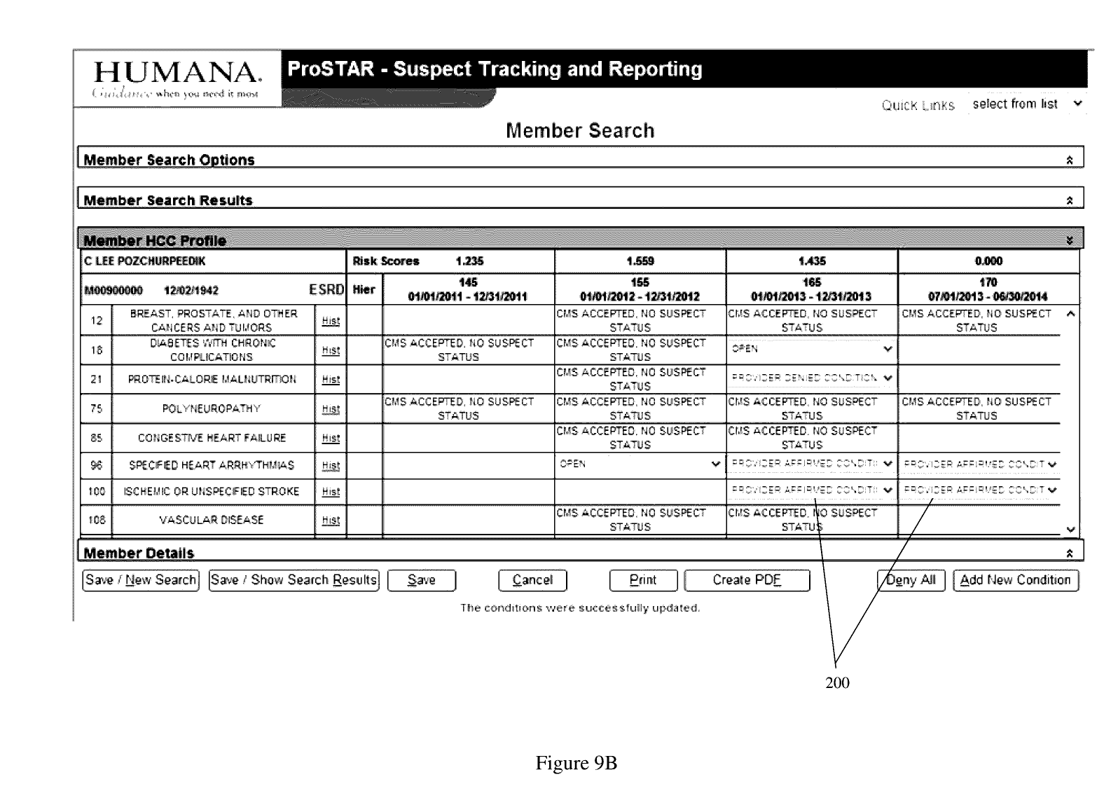

Referring to FIG. 9A, an Add Affirmed Condition screen for an ESRD Model Member according to an example embodiment is shown. The user is prompted to enter a diagnosis code (e.g., ICD9 code) 190, and the Date of Service 192. Next, the user performs a validation step by selecting the Validate option 194. A message 196 is displayed below the Validate option, informing the user which health conditions will be added when the Confirm option 198 is selected. Selecting the Confirm option 198 causes the new conditions to be added to the member's profile. Referring to FIG. 9B, the new conditions appear in the member profile as a “Provider Affirmed Condition” 200.

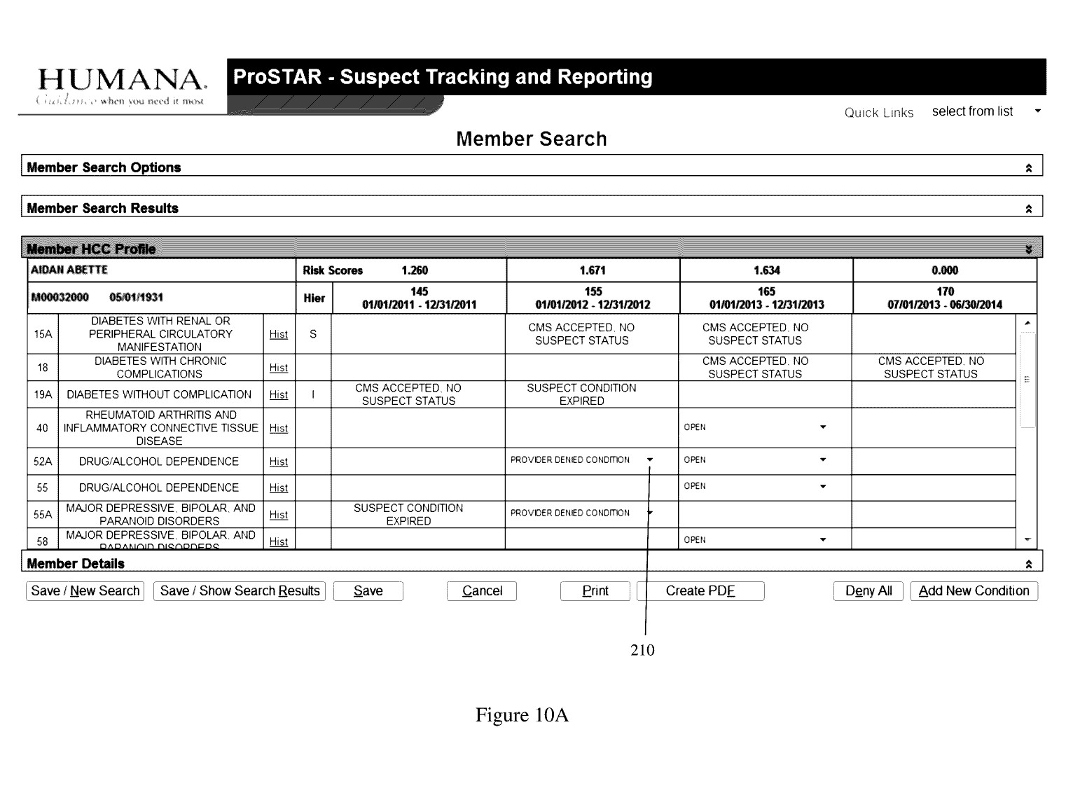

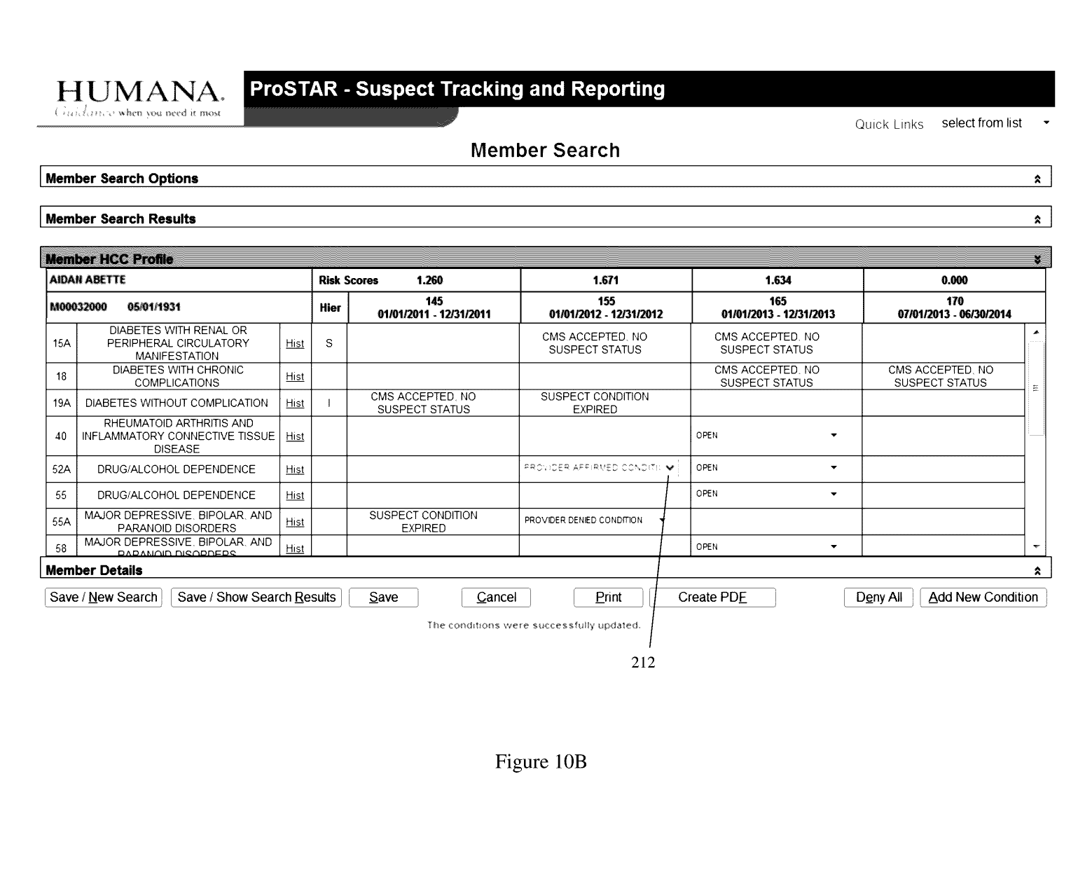

Users are also able to correct the status of a condition that was previously identified as “Provider Denied Status.” Referring to FIG. 10A (Medical HCC Model), a current status Member HCC Profile screen for a Medical HCC Model member according to an example embodiment is shown. The user opens the menu for the “Provider Denied Condition” 210 and affirms the condition through the Medical HCC Model Affirm Condition screens as shown in FIGS. 4A and 4B. After saving the condition status update, the Member HCC Profile screen displays the correct condition status of “Provider Affirmed Condition” 212 as shown in FIG. 10B.

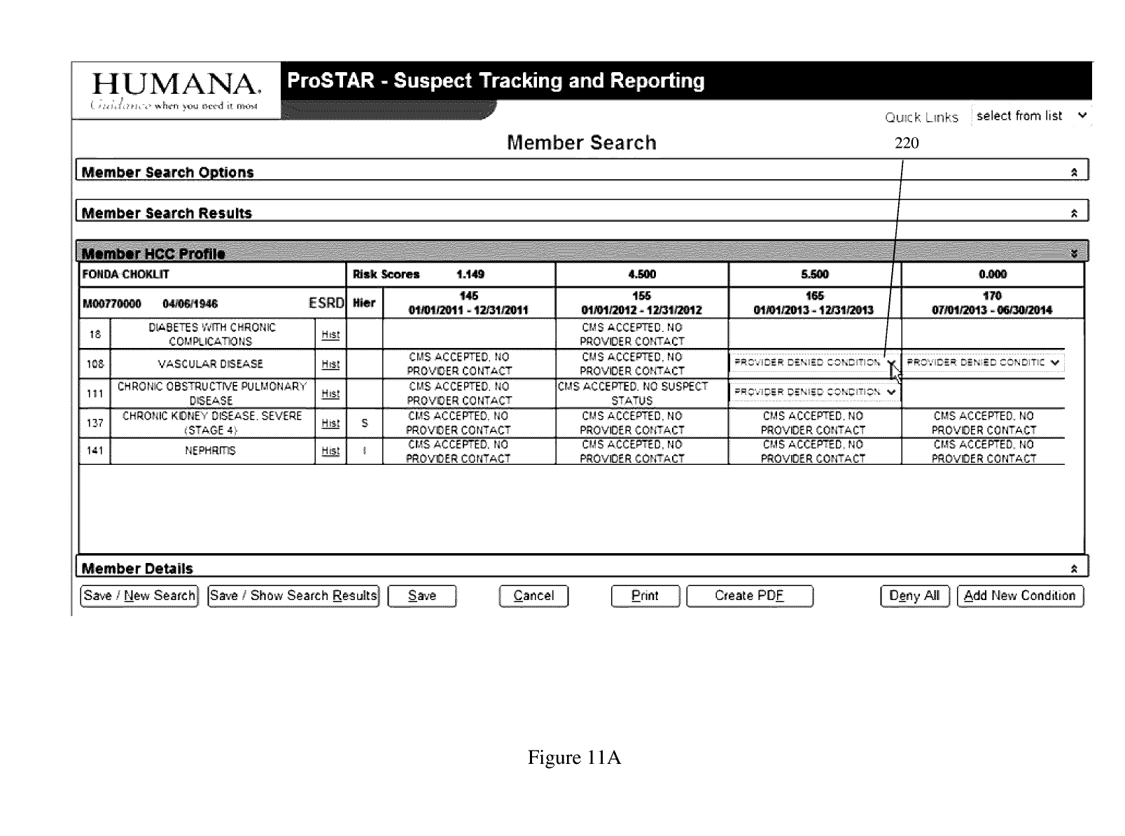

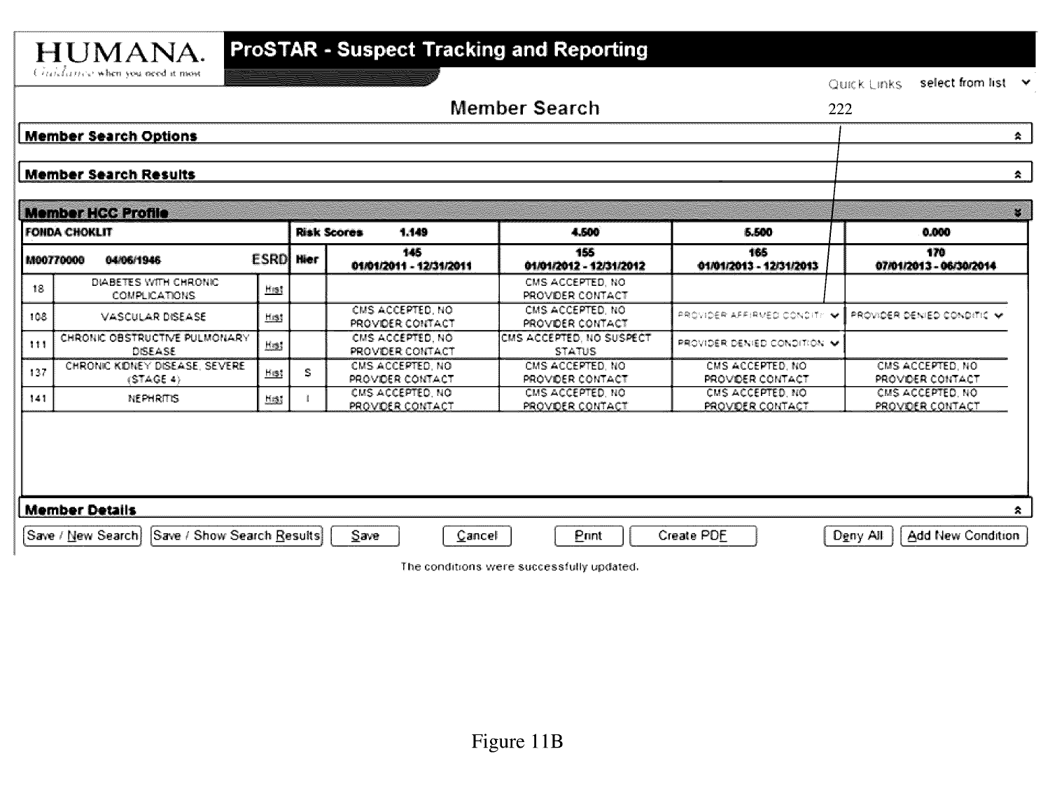

Referring to FIG. 11A, a current status Member HCC Profile screen for an ESRD HCC Model member according to an example embodiment is shown. The user opens the menu for the “Provider Denied Condition” 220 and affirms the condition through the ESRD HCC Model Affirm Condition screens as shown in FIGS. 5A and 5B. After saving the condition status update, the Member HCC Profile screen displays the correct condition status of “Provider Affirmed Condition” 222 as shown in FIG. 11B.

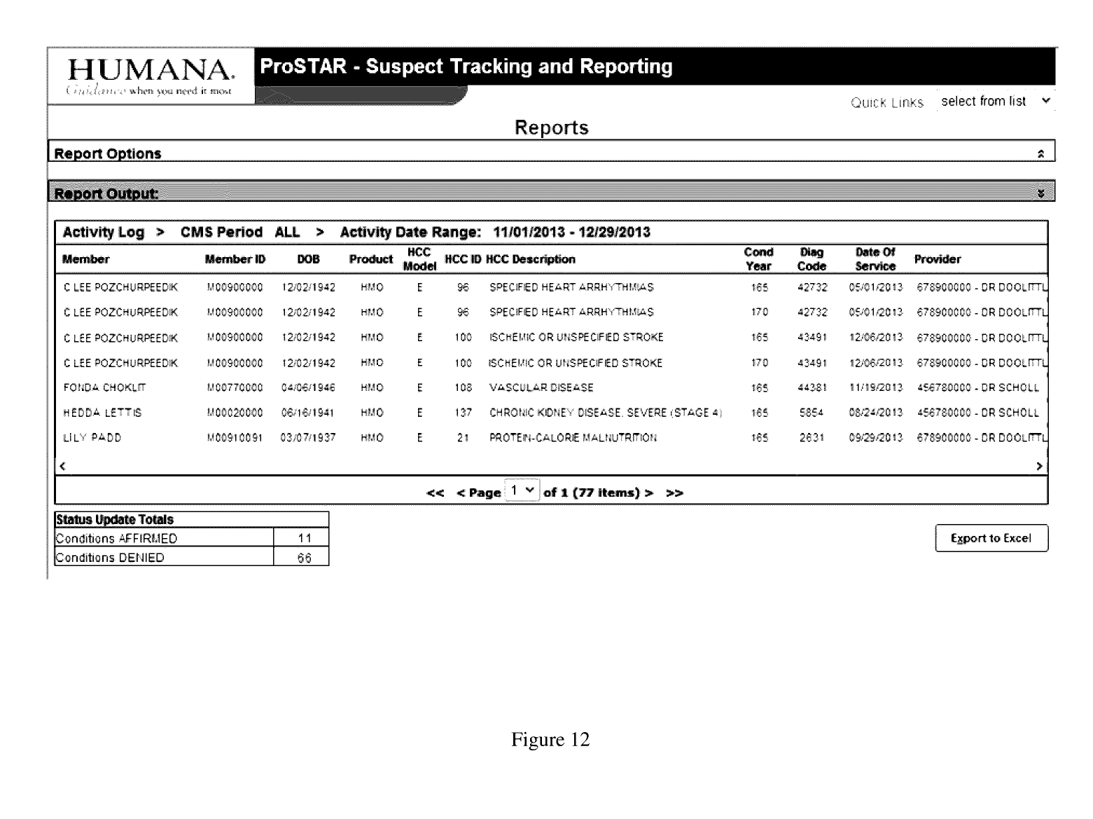

Referring to FIG. 12, an Activity Log report screen according to an example embodiment is shown. In an example embodiment, the report presents a list of status updates based on the search criteria of provider, plan type (e.g., health maintenance organization HMO, private fee-for-service plan PFFS, local preferred provider organization LPPO, and regional preferred provider organization RPPO), condition year, and date range. For each updated health condition status, the report provides identifying information for the member as well as applicable plan product, HCC Model Identifier, HCC Description, and details related to when the condition was identified by the provider.

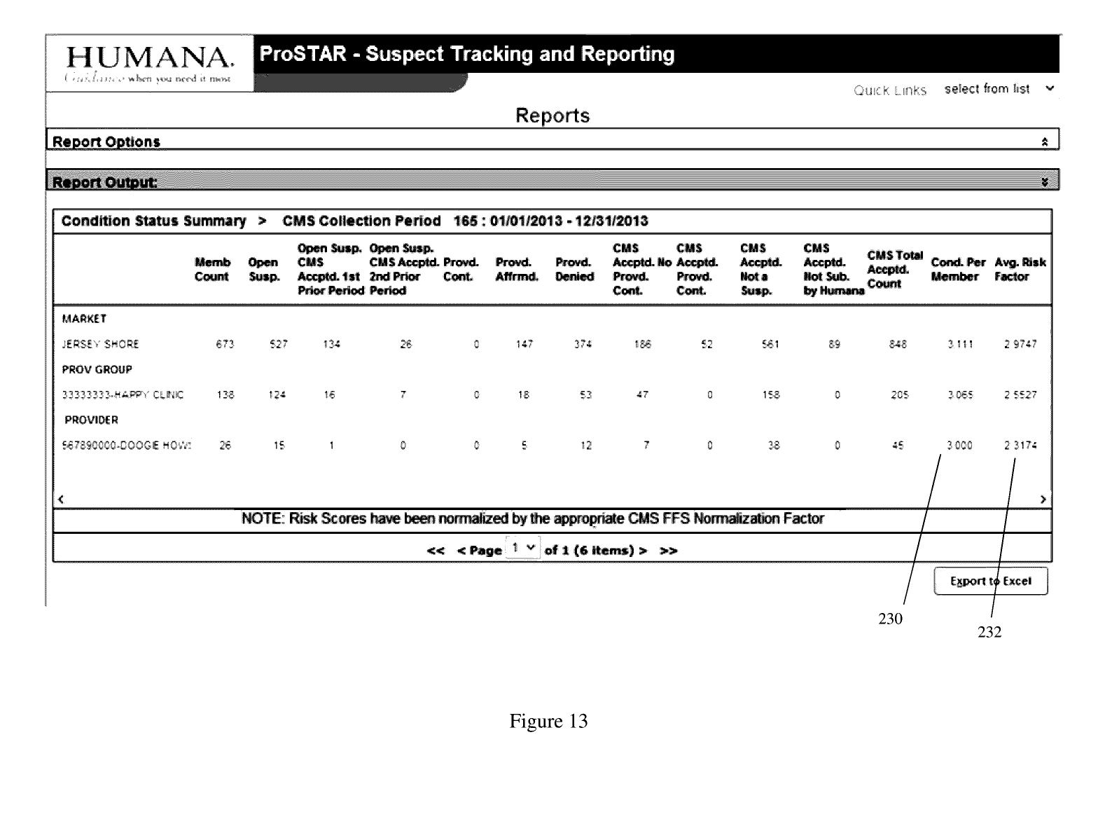

Referring to FIG. 13, a Condition Status Summary report screen according to an example embodiment is shown. In an example embodiment, the report presents a series of counts related to health condition status changes, an average number of conditions 230 and an average risk factor 232 for the subject members.

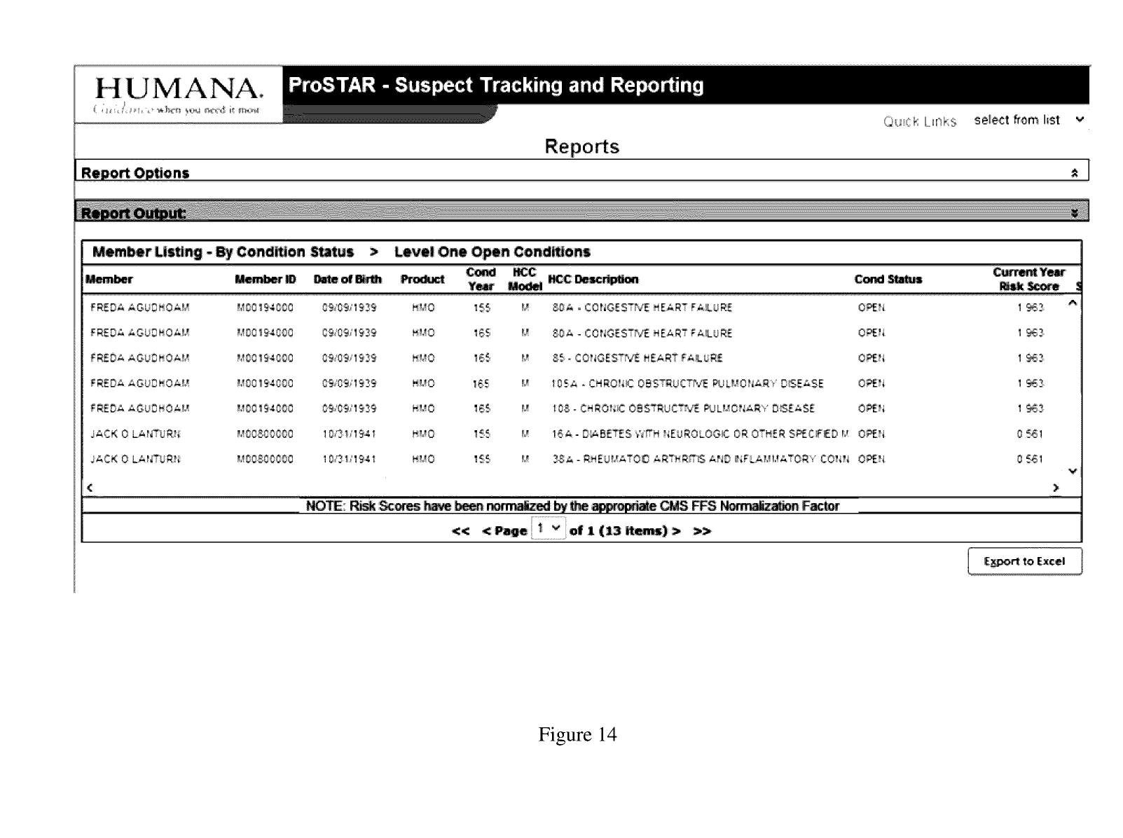

Referring to FIG. 14, a Member Listing—By Condition Status report screen according to an example embodiment is shown. For each condition status, the report provides identifying information for the member as well as the applicable plan product, HCC Model Identifier, HCC Description, condition status, current year risk score, and details related to when the condition was identified by the health care provider.

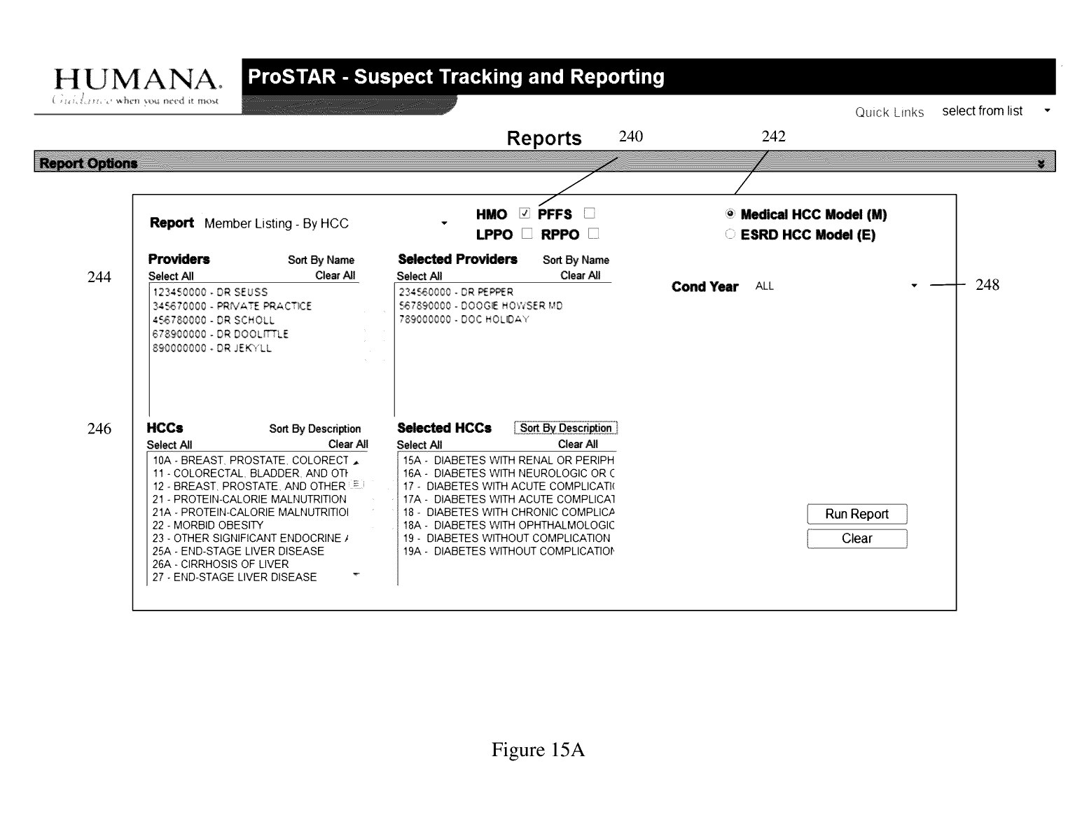

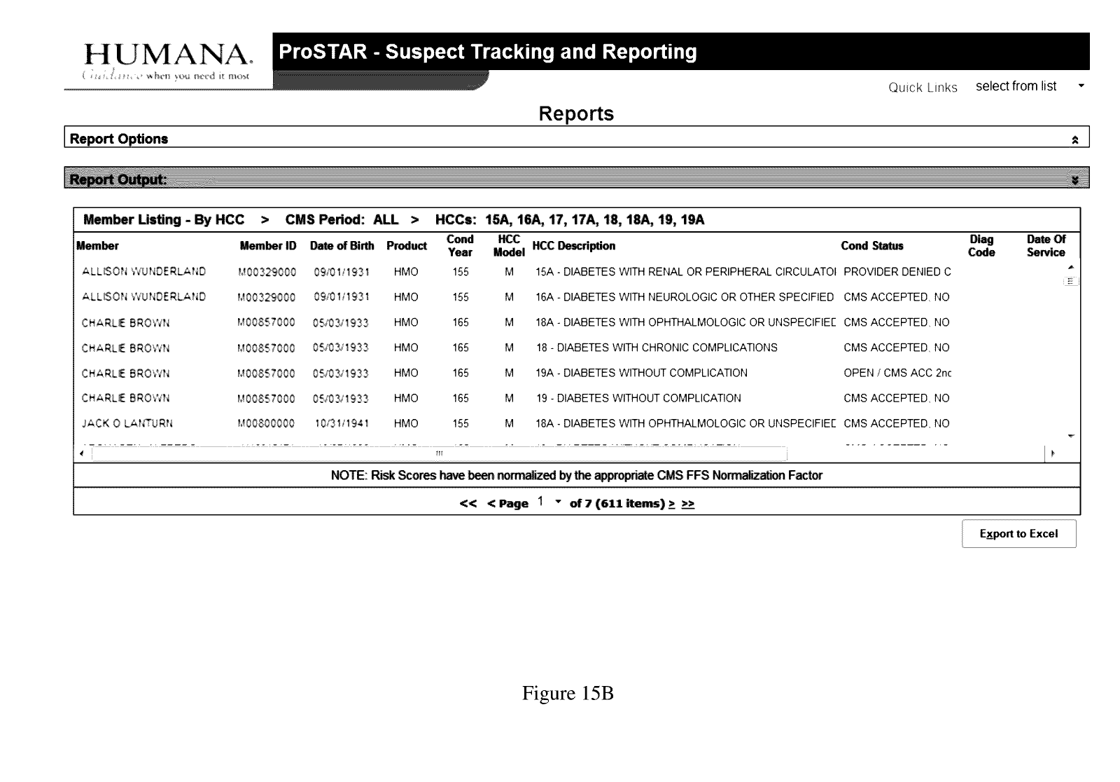

Referring to FIG. 15A, a first Member Listing—By HCC search screen according to an example embodiment is shown. After selecting one or more products 240 and an HCC model 242, a user can select providers 244 and specific HCCs 246 from respective lists. The user can also specify a condition year 248. Referring to FIG. 15B, a first Member Listing—By HCC report screen according to an example embodiment is shown. The report presents a list of members' condition records matching the selection criteria.

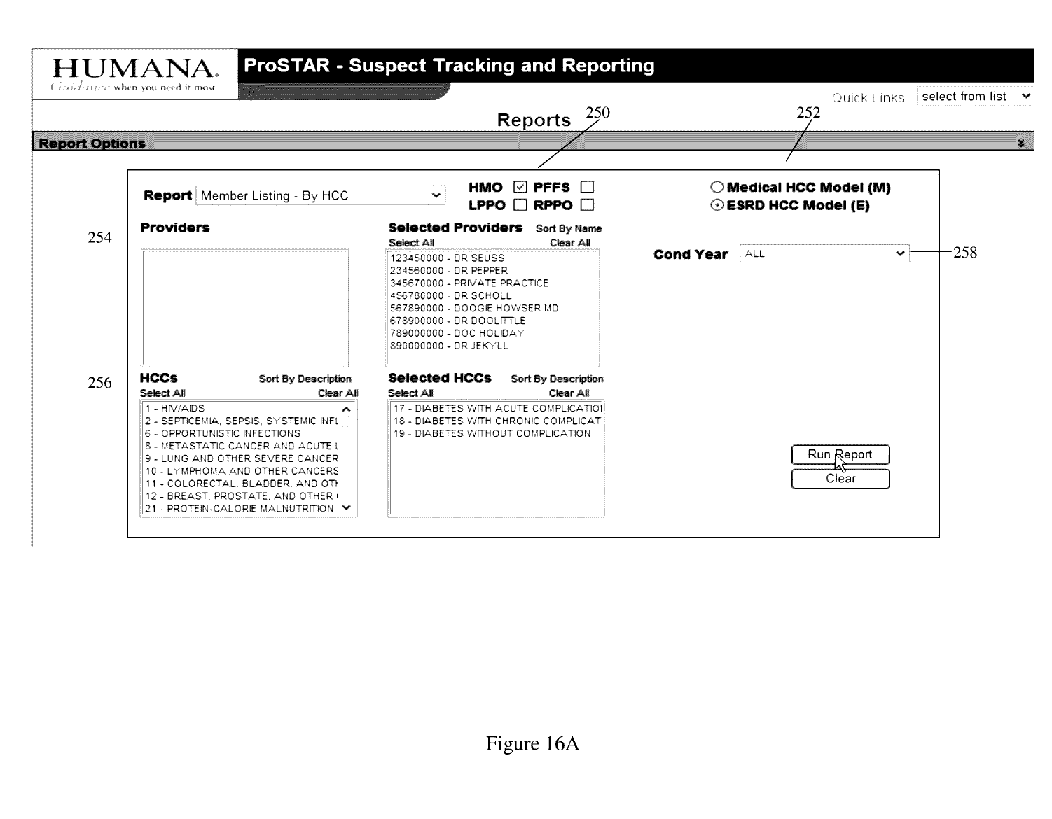

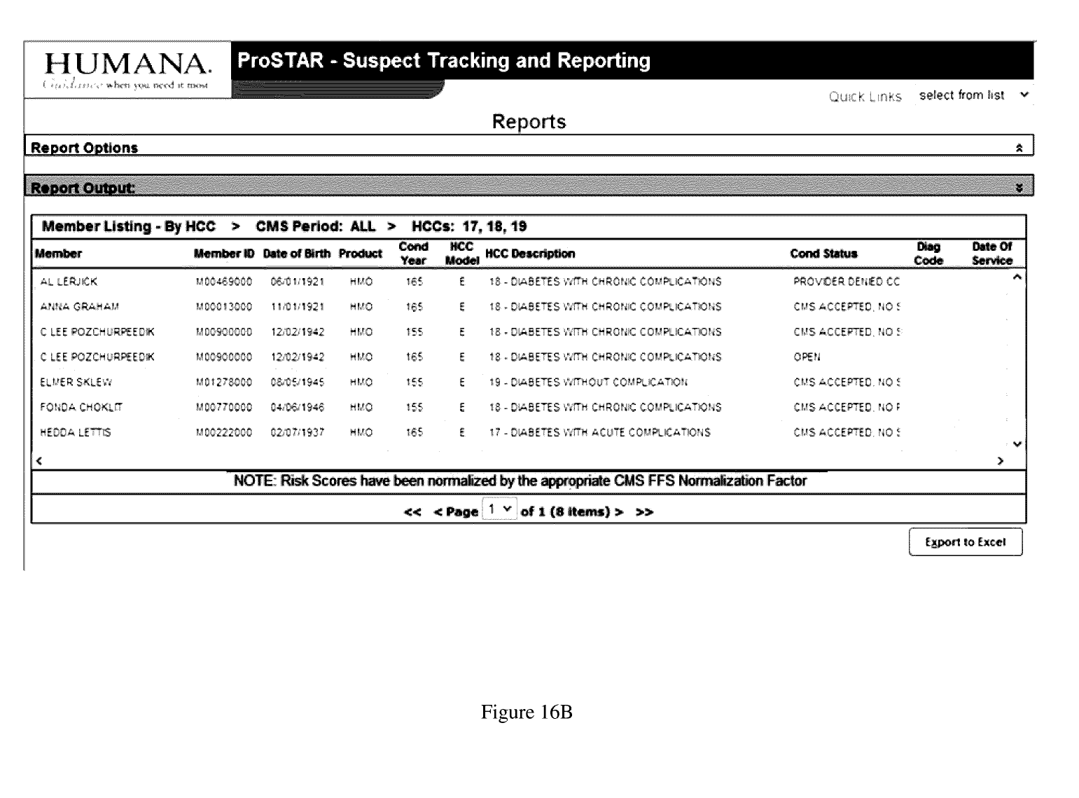

Referring to FIG. 16A, a second Member Listing—By HCC search screen according to an example embodiment is shown. After selecting one or more products 250 and an HCC model 252, a user can select providers 254 and specific HCCs 256 from respective lists. The user can also specify a condition year 258. Referring to FIG. 16B, a second Member Listing—By HCC report screen according to an example embodiment is shown. The report presents a list of members' condition records matching the selection criteria.

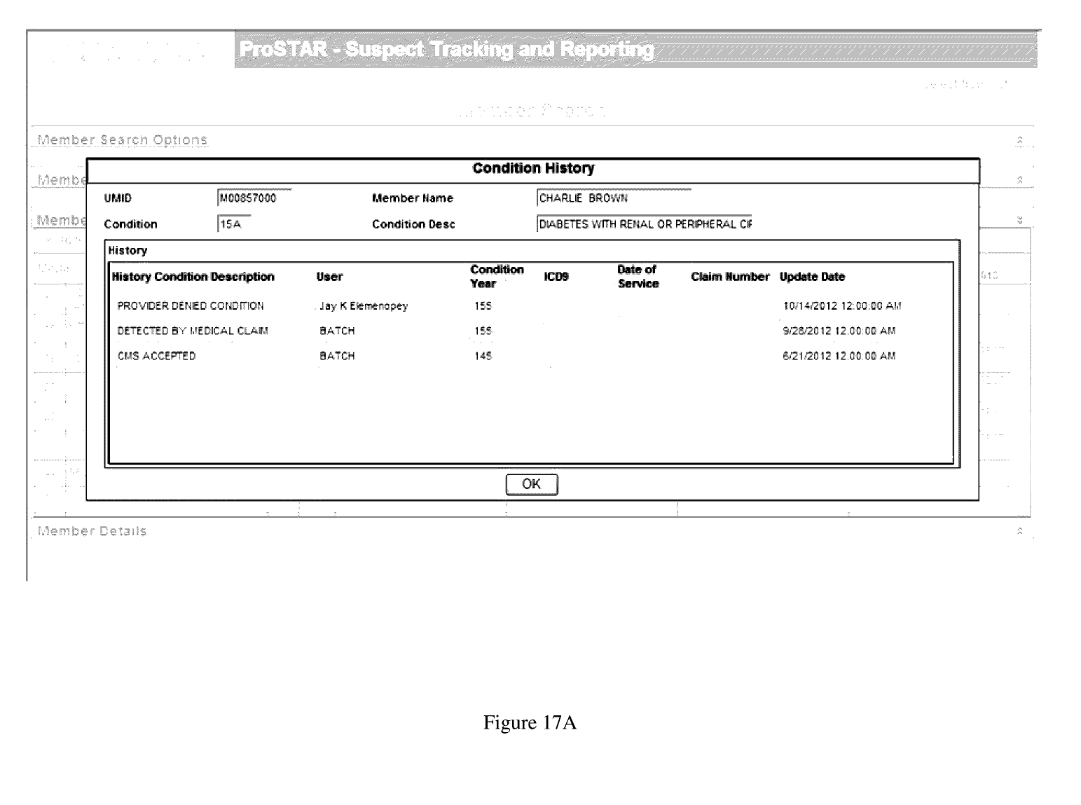

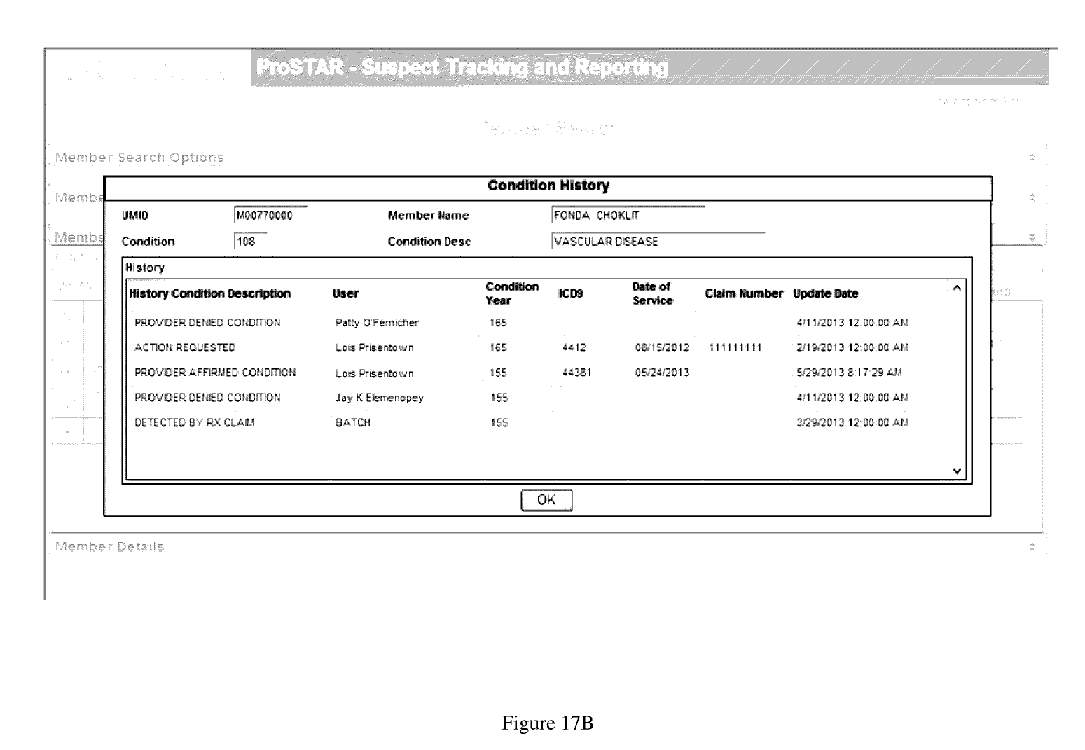

Referring again to FIGS. 3A and 3B, a user may select a history option 128 for each health condition to view all status changes to a condition within multiple CMS data collection periods. Referring to FIG. 17A, a condition history screen for a Medical HCC Model member is shown. Referring to FIG. 17B, a condition history screen for an ESRD HCC Model member is shown. The condition history screen displays a description of the history condition, the user that completed the status change, the condition year, the diagnosis code (if applicable), the date of service (if applicable), the claim number (if applicable), and the update date.

Based upon information contained in the medical record there are several possible actions the user can perform:

TABLE 4
Activity Log Details

| | |
|---|---|
| Member Name | (displays members who have been updated |
| | in the STAR database during the |
| | period for which the report was generated) |
| Member ID | unique member identifier |
| DOB | member date of birth |
| HCC ID | condition updated in the STAR database for |
| | this member |
| HCC Description | condition description for condition updated |
| | in the STAR database |
| Provider ID | primary care physician associated with the |
| | member that was updated |
| User Name | STAR application user that performed the |
| | update to this member |
| ICD9 | diagnosis detail applicable to those conditions |
| | that were “affirmed” during the |
| | period for which the report was generated |
| Date of Service | applicable to those conditions that were |
| | “affirmed” during the period for which |
| | the report was generated |
| Update Date | date that the condition was updated in the |
| | STAR database |
| Status | action that was performed for the updated |
| | condition |

TABLE 5
Condition Status Summary Report Details

| | |
|---|---|
| Member Counts | total number of membership associated with |
| | provider(s) |
| Open Suspects | total suspects identified during the current period |
| Open CMS | total suspects that were “CMS accepted” |
| Accptd. 1st | conditions from prior period |
| Prior Period | |
| Open CMS | total suspects that were “CMS accepted” |
| Accptd. 2nd | conditions from two prior periods |
| Prior Period | |
| Provd. Cont. | total suspects for which the provider has been |
| | contacted, but provider has neither affirmed or |
| | denied the condition |
| Provd. Affirmd. | total suspects the provider has affirmed - no |
| | supporting claim or encounter has yet been received |
| Provd. Denied | total suspects the provider has denied |
| CMS Accptd. | total conditions that have been accepted by CMS; |
| No Provd. Cont. | provider was never contacted |
| CMS Accptd | total conditions that have been accepted by CMS; |
| Provd Cont. | provider was contacted |
| CMS Accptd. | total conditions that have been accepted by CMS; |
| No Suspect | condition was not previously a Suspect |
| CMS Total | total of all “CMS accepted” conditions |
| Accptd. Count | |
| Cond. Per | average number of conditions per member |
| Member | |
| Avg. Risk | average risk score per member |
| Factor | |

While certain embodiments of the present invention are described in detail above, the scope of the invention is not to be considered limited by such disclosure, and modifications are possible without departing from the spirit of the invention as evidenced by the claims. For example, elements of the user interface may be varied and fall within the scope of the claimed invention. Various aspects of status conditions and data presentation may be varied and fall within the scope of the claimed invention. Additional code models may be defined and integrated into menus that allow a user to select a code model. One skilled in the art would recognize that such modifications are possible without departing from the scope of the claimed invention.

APPENDIX A
GLOSSARY OF MEMBER CONDITION STATUS TERMS:

| | |
|---|---|
| ACTION REQUESTED | in a review of the member's medical record, |
| | a medical record coder found a previously |
| | unreported condition and requested that it |
| | be processed for submission to CMS. |
| OPEN | the “suspect condition” has been |
| | identified but no other action has been |
| | taken. |
| OPEN/CMS | this condition was accepted by CMS during |
| ACC 1^{st} PRIOR | the most recent reporting year and is |
| PERIOD | automatically a suspect for the current |
| | reporting year. |
| OPEN/CMS | this condition was accepted by CMS two |
| ACC 2^{nd} PRIOR | reporting periods ago and is automatically |
| PERIOD | a suspect for the current reporting year. |
| PROVIDER AFFIRMED | provider agrees that the medical record |
| CONDITION | indicates the condition identified and |
| | an encounter is forthcoming (also called |
| | a “TRUE POSITIVE”) |
| PROVIDER DENIED | provider states that no encounter will |
| CONDITION | be submitted for the suspect condition |
| | (also called a “FALSE POSITIVE”) |
| CMS ACCEPTED, NO | the suspect condition has been resolved |
| PROVIDER CONTACT | (encounter accepted) even though the |
| | provider was not contacted regarding |
| | this suspect condition. |
| CMS ACCEPTED, | an encounter for the suspect condition |
| PROVIDER | has been received and processed by CMS; |
| CONTACTED | prior to resolution, a health benefits |
| | associate contacted the provider. |
| CMS ACCEPTED, NO | an encounter condition has been accepted |
| SUSPECT STATUS | by CMS but was not previously identified |
| | by a healthcare benefits provider as a |
| | suspect. |
| CMS ACCEPTED, NOT | an encounter condition has been accepted |
| SUBMITTED BY | by CMS but was submitted by a different |
| HUMANA | health plan |
| CMS ACCEPTED, | an encounter condition has been accepted |
| ACTION REQUESTED | by CMS; prior to resolution the condition |
| | was in Action Requested status. |
| HUMANA DELETED | A health benefits associate submitted an |
| | encounter for a condition to CMS, and |
| | then submitted a delete request to CMS |
| | for the same encounter at a later date. |
| SUSPECT CONDITION | for any variety of reasons, a health |
| EXPIRED | benefits associate has decided to withdraw |
| | a suspect condition after deciding the |
| | condition would not be worked. |
| CMS CANCELLED | CMS has informed the health benefits plan |
| | that no payment will be issued for the |
| | condition. |

1. A computerized method for coding medical records comprising one or more computers executing instructions to:
(a) store in at least one database a plurality of medical code model identifiers and in association with each medical code model identifier, a plurality of health condition codes;
(b) generate for display at a user computer a display comprising a medical record for a member of a health benefits plan, said medical record comprising:
(1) identifying data for said member;
(2) a medical code model identifier; and
(3) data for at least one suspect medical condition comprising:
(i) identifying data for at least one health condition; and
(ii) an open condition status indicator;
(c) receive from a computer user a request to confirm said at least one medical condition with said open condition status indicator;
(d) receive from said computer user a diagnosis code corresponding to said medical condition for which a request to confirm was received;
(e) locate in said plurality of health condition codes for said medical code model identifier at least one health condition code correlated with said diagnosis code;
(f) generate for display at said user computer a first display comprising:
(i) said at least one health condition code; and
(ii) a confirm option;
(g) receive from said computer user a selection of said confirm option to confirm said diagnosis code and said health condition code; and
(h) update said first display to indicate said at least one suspect medical condition is affirmed;
(i) receive from said computer user a request to add a new health condition to said medical record;
(j) receive from said computer user a second diagnosis code;
(k) locate in said plurality of health condition codes for said medical code model identifier at least one health condition code correlated with said second diagnosis code; and
(l) update said first screen to indicate said at least one health condition code has been added to said medical record.

2. The computerized method of claim 1 wherein said medical code model identifier is selected from the group consisting of:
a medical hierarchical condition code model and an end-stage renal disease code model.

3. The computerized method of claim 1 wherein said instruction to update said first screen to indicate said at least one suspect medical condition is affirmed comprises an instruction to indicate said at least one suspect medical condition is affirmed for a specified period.

4. The computerized method of claim 1 wherein said one or more computers further execute an instruction to receive a provider date of service.

5. (canceled)

6. The computerized method of claim 1 wherein said instruction to update said first display to indicate said at least one medical condition has been added comprises an instruction to indicate said at least one medical condition has been added for a specified period.

7. The computerized method of claim 1 wherein said instruction to update said first screen to indicate said at least one medical condition has been added comprises an instruction to indicate said at least one medical condition has been added for a plurality of periods.

8. A computerized method for coding medical records comprising one or more computers executing instructions to:
(a) store in at least one database a plurality of medical code model identifiers and in association with each medical code model identifier, a plurality of health condition codes;
(b) generate for display at a user computer a display comprising a medical record for a member of a health benefits plan, said medical record comprising:
(1) identifying data for said member;
(2) a medical code model identifier; and
(3) an option to add at least one medical condition to said medical record;
(c) receive from a computer user a selection of said option to add at least one medical condition to said medical record;
(d) receive from said computer user a diagnosis code;
(e) locate in said plurality of health condition codes for said medical code model identifier at least one health condition code correlated with said diagnosis code; and
(f) update said display to indicate said at least one medical condition has been added to said medical record.

9. The computerized method of claim 8 wherein said medical code model identifier is selected from the group consisting of:
a medical hierarchical condition code model and an end-stage renal disease code model.

10. The computerized method of claim 8 wherein said instruction to update said display to indicate said at least one medical condition has been added comprises an instruction to indicate said at least one medical condition has been added for a specified period.

11. The computerized method of claim 8 wherein said instruction to update said display to indicate said at least one medical condition has been added comprises an instruction to indicate said at least one medical condition has been added for a plurality of periods.

12. The computerized method of claim 8 wherein said one or more computers further execute an instruction to receive a provider date of service.

13. A computerized method for coding medical records comprising one or more computers executing instructions to:
(a) store in at least one database member records for a plurality of members of a health benefits plan;
(b) store in at least one database:
(i) a plurality of medical code model identifiers; and
(ii) in association with each medical code model identifier a plurality of health condition codes correlated with diagnosis codes;
(c) generate for display at a user computer a first screen comprising a medical record for a member of a health benefit plan, said medical record comprising:
(i) identifying data for said member;
(ii) a medical code model identifier; and
(iii) data for at least one suspect medical condition comprising:
(i) identifying data for at least one health condition; and
(ii) an open condition status indicator; and
(d) receive from a computer user a request to confirm said at least one medical condition with said open condition status indicator;
(e) receive from said computer user a diagnosis code corresponding to said health condition;
(f) using said medical model code identifier and said diagnosis code, locate at least one health condition code correlated with said diagnosis code;
(g) generate for display at said user computer a second screen comprising:
(i) said at least one health condition code; and
(ii) a confirm option;
(h) receive from said computer user a selection of said confirm option to confirm said diagnosis code and said health condition code; and
(i) update said first screen to indicate said at least one suspect medical condition is affirmed;
(j) receive from said computer user a request to add a new health condition to said medical record;
(k) receive from said computer user a second diagnosis code;
(l) locate in said plurality of health condition codes for said medical code model identifier at least one health condition code correlated with said second diagnosis code; and
(m) update said first screen to indicate said at least one medical condition has been added to said member medical record.

14. The computerized method of claim 13 wherein said medical code model identifier is selected from the group consisting of:
a medical hierarchical condition code model and an end-stage renal disease code model.

15. The computerized method of claim 13 wherein said instruction to update said display to indicate said at least one suspect medical condition is affirmed comprises an instruction to indicate said at least one suspect medical condition is affirmed for a specified period.

16. The computerized method of claim 13 wherein said one or more computers further execute an instruction to receive a provider date of service.

17. (canceled)

18. The computerized method of claim 13 wherein said instruction to update said first screen to indicate said at least one medical condition has been added comprises an instruction to indicate said at least one medical condition has been added for a specified period.

19. The computerized method of claim 13 wherein said instruction to update said first screen to indicate said at least one medical condition has been added comprises an instruction to indicate said at least one medical condition has been added for a plurality of periods.

20. The computerized method of claim 19 wherein instruction to indicate said at least one medical condition has been added for a plurality of periods comprises an instruction to indicate a first health condition code is added to a first period and a second health condition code is added to a second period.
